(19) United States
(12) Patent Application Publication
(10) Pub. No.: US 2026/0127824 A1
(43) Pub. Date: May 7, 2026

(54) SYSTEMS AND METHODS FOR GENERATING THREE-DIMENSIONAL (3D) OCCUPANCY DATA

(71) Applicant: QUALCOMM Incorporated, San Diego, CA (US)

(72) Inventors: Yunxiao SHI, San Diego, CA (US); Hong CAI, San Diego, CA (US); Shizhong Steve HAN, San Diego, CA (US); Yinhao ZHU, La Jolla, CA (US); Jisoo JEONG, San Diego, CA (US); Fatih Murat PORIKLI, San Diego, CA (US); Amin ANSARI, Kirkland, WA (US)

(21) Appl. No.: 19/036,817

(22) Filed: Jan. 24, 2025

Related U.S. Application Data
(60) Provisional application No. 63/717,863, filed on Nov. 7, 2024.

(51) Int. Cl. G06T 17/05; G06N 20/00; G06V 10/44; G06V 10/80

(52) U.S. Cl. CPC G06T 17/05; G06N 20/00; G06V 10/44; G06V 10/806

(57) ABSTRACT

Systems and techniques are described herein for generating three-dimensional (3D) occupancy data. For instance, a method for generating three-dimensional (3D) occupancy data is provided. The method may include processing an image of a scene using an image encoder to generate image features; processing the image features to generate bird's-eye-view (BEV) features; generating a first 3D occupancy prediction based on the BEV features; generating a second 3D occupancy prediction based on the image features; and combining the first 3D occupancy prediction and the second 3D occupancy prediction to generate a third 3D occupancy prediction.

### CROSS-REFERENCE TO RELATED APPLICATIONS

This application claims the benefit of U.S. Provisional Application No. 63/717,863, filed Nov. 7, 2024, which is incorporated herein by reference in its entirety.

### TECHNICAL FIELD

The present disclosure generally relates to three-dimensional (3D) occupancy data. For example, aspects of the present disclosure include systems and techniques for generating 3D occupancy data.

### BACKGROUND

Many devices include one or more cameras. For example, a vehicle may include cameras facing one or more directions away from the vehicle. A camera can capture images using an image sensor of the camera, which can include an array of photodetectors. Some devices can analyze image data captured by an image sensor to detect an object within the image data.

Object detections based on perception data (such as images from a camera) may inform a driving systems (e.g., autonomous, semi-autonomous, or assisted driving systems, such as an advanced driver assistance system (ADAS)) what area is drivable and what objects (e.g., road users, other vehicles, bikes, pedestrian, etc.) are present and/or are moving in the environment around the vehicle. The driving system then makes decisions about how to move (e.g., slower, faster, stop, changing lanes, turning, a path to take, etc.) based on object detections, such as drivable areas and/or detected objects.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for generating three-dimensional (3D) occupancy data. According to at least one example, a method is provided for generating three-dimensional (3D) occupancy data. The method includes: processing an image of a scene using an image encoder to generate image features; processing the image features to generate bird's-eye-view (BEV) features; generating a first 3D occupancy prediction based on the BEV features; generating a second 3D occupancy prediction based on the image features; and combining the first 3D occupancy prediction and the second 3D occupancy prediction to generate a third 3D occupancy prediction.

In another example, an apparatus for generating three-dimensional (3D) occupancy data is provided that includes at least one memory and at least one processor (e.g., configured in circuitry) coupled to the at least one memory. The at least one processor configured to: process an image of a scene using an image encoder to generate image features; process the image features to generate bird's-eye-view (BEV) features; generate a first 3D occupancy prediction based on the BEV features; generate a second 3D occupancy prediction based on the image features; and combine the first 3D occupancy prediction and the second 3D occupancy prediction to generate a third 3D occupancy prediction.

In another example, a non-transitory computer-readable medium is provided that has stored thereon instructions that, when executed by one or more processors, cause the one or more processors to: process an image of a scene using an image encoder to generate image features; process the image features to generate bird's-eye-view (BEV) features; generate a first 3D occupancy prediction based on the BEV features; generate a second 3D occupancy prediction based on the image features; and combine the first 3D occupancy prediction and the second 3D occupancy prediction to generate a third 3D occupancy prediction.

In another example, an apparatus for generating three-dimensional (3D) occupancy data is provided. The apparatus includes: means for processing an image of a scene using an image encoder to generate image features; processing the image features to generate bird's-eye-view (BEV) features; means for generating a first 3D occupancy prediction based on the BEV features; means for generating a second 3D occupancy prediction based on the image features; and means for combining the first 3D occupancy prediction and the second 3D occupancy prediction to generate a third 3D occupancy prediction.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example architecture of an image capture and processing system, in accordance with some examples;

FIG. 2 is a conceptual diagram illustrating examples of images and corresponding semantic maps, in accordance with some examples;

FIG. 3 is a block diagram illustrating an imaging system that processes images of an environment using ML model(s) to generate a 3D occupancy prediction map of the environment, in accordance with some examples;

FIG. 4 is a birds-eye view diagram illustrating a vehicle along with images captured using sensors coupled to the vehicle, in accordance with some examples;

FIG. 5 is a block diagram illustrating an example system for generating 3D occupancy data, according to various aspects of the present disclosure;

FIG. 6 is a block diagram illustrating an example implementation of the BEV branch of FIG. 5 to provide additional detail regarding the BEV branch of FIG. 5, according to various aspects of the present disclosure;

FIG. 7 is a block diagram illustrating an example implementation of the point branch of FIG. 5 to provide additional detail regarding the point branch of FIG. 5, according to various aspects of the present disclosure;

FIG. 8 is a block diagram illustrating another example system for generating 3D occupancy data, according to various aspects of the present disclosure;

FIG. 9 is a block diagram illustrating yet another example system for generating 3D occupancy data, according to various aspects of the present disclosure;

FIG. 10 is a block diagram illustrating yet another example system for generating 3D occupancy data, according to various aspects of the present disclosure;

FIG. 11A is a block diagram illustrating yet another example system for generating 3D occupancy data, according to various aspects of the present disclosure;

FIG. 11B is a block diagram illustrating yet another example system for generating 3D occupancy data, according to various aspects of the present disclosure;

FIG. 12 is a flow diagram illustrating an example process for generating 3D occupancy data, in accordance with aspects of the present disclosure;

FIG. 13 is a block diagram illustrating an example of a deep learning neural network that can be used to perform various tasks, according to some aspects of the disclosed technology;

FIG. 14 is a block diagram illustrating an example of a convolutional neural network (CNN), according to various aspects of the present disclosure; and

FIG. 15 is a block diagram of an example transformer in accordance with some aspects of the disclosure;

FIG. 16 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

A camera is a device that receives light and captures image frames, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during capture of one or more image frames, such as ISO, exposure time, aperture size, f/stop, shutter speed, focus, and gain. For example, settings or parameters can be applied to an image sensor for capturing the one or more image frames. Other camera settings can configure post-processing of one or more image frames, such as alterations to contrast, brightness, saturation, sharpness, levels, curves, or colors. For example, settings or parameters can be applied to a processor (e.g., an image signal processor or ISP) for processing the one or more image frames captured by the image sensor.

A device that includes a camera can analyze image data captured by an image sensor to detect, recognize, classify, and/or track an object within the image data. For instance, by detecting and/or recognizing an object in multiple video frames of a video, the device can track movement of the object over time.

Object detections based on perception data (such as images from a camera) may inform a driving systems (e.g., autonomous, semi-autonomous, or assisted driving systems, such as an advanced driver assistance system (ADAS)) what area is drivable and what objects (e.g., road users, other vehicles, bikes, pedestrian, etc.) are present and/or are moving in the environment around the vehicle. The driving system then makes decisions about how to move (e.g., slower, faster, stop, changing lanes, turning, a path to take, etc.).

Driving systems (e.g., autonomous, semi-autonomous, and/or assisted driving systems, such as an advanced driver assistance systems (ADAS)) of vehicles may assist a driver of a vehicle. Such driving systems may operate at various levels of autonomy. For example, autonomy level 0 requires full control from the driver as the vehicle has no autonomous driving system, and autonomy level 1 involves basic assistance features, such as cruise control, in which case the driver of the vehicle is in full control of the vehicle. Autonomy level 2 refers to semi-autonomous driving, where the vehicle can perform functions, such as drive in a straight path, stay in a particular lane, control the distance from other vehicles in front of the vehicle, or other functions. Autonomy levels 3, 4, and 5 include much more autonomy. For example, autonomy level 3 refers to an on-board autonomous driving system that can take over all driving functions in certain situations, where the driver remains ready to take over at any time if needed. Autonomy level 4 refers to a fully autonomous experience without requiring a user's help, even in complicated driving situations (e.g., on highways and in heavy city traffic). With autonomy level 4, a person may still remain in the driver's seat behind the steering wheel. Vehicles operating at autonomy level 4 can communicate and inform other vehicles about upcoming maneuvers (e.g., a vehicle is changing lanes, making a turn, stopping, etc.). Autonomy level 5 vehicles fully autonomous, self-driving vehicles that operate autonomously in all conditions. A human operator is not needed for the vehicle to take any action.

One way of representing object detections (e.g., for processing and/or making determinations, such as by a driving system) is to represent detected objects in a two-dimensional (2D) bird's-eye-view (BEV) representation of an environment. For vehicles that travel exclusively on the ground, processing detected objects in a ground plane may make sense because objects in the ground plane may be relevant to the vehicles while objects above the ground plane may be less relevant to the vehicle. Accordingly, some techniques may generate a 2D BEV representation of a scene flattening all detected objects into a 2D plane. A 2D BEV representation may conserve computational resources (e.g., power and/or computing time). However a 2D BEV representation may not accurately represent small objects. For example, in various upsampling, downsampling, and/or averaging operations of processing image data to generate a 2D BEV representation, relatively small objects may be lost.

Another way of representing object detections is a sparse point-based representation. A sparse point-based representation of an environment may accurately represent small objects. However, it may be computationally inefficient to represent large surfaces (e.g, the ground) using points. For example, based on a density of the points, it may take thousands of point to represent a few hundred meters of road surface.

A 2D BEV representation may be good at modeling large surfaces and may accurately capture relatively large objects (such as cars and buildings). A point-based representation may be good at modeling smaller objects (such as pedestrians, bicyclists, and/or motorcycles). On the other hand, a point-based representation may not be good at capturing large surfaces and underperform a 2D BEV representation for large surfaces, including for example, drivable surface, sidewalk, terrain, and manmade (buildings). Additionally, in order to represent large surfaces, a relatively large number of points May be used, which can significantly increase the cost of any attention operations that process the points.

Table 1 and Table 2 include data related to using a 2D BEV representation compared to using a point-based representation for various classes of detected objects. The numbers in Table 1 and Table 2 represent the mean intersection over union values which measures the accuracy of the semantic segmentation in 3D. Higher numbers are preferable. For example, the higher the number the more efficient and/or accurate the representation of the object in the format.

TABLE 1

| | mIoU | others | barrier | bicycle | bus | car | cons. veh | motorcycle | pedestrian |
|---|---|---|---|---|---|---|---|---|---|
| BEV | 30.51 | 5.36 | 35.38 | 10.45 | 36.25 | 42.34 | 17.87 | 14.45 | 17.11 |
| Points | 30.86 | 9.68 | 36.17 | 15.86 | 38.65 | 43.41 | 21.81 | 17.21 | 14.63 |

TABLE 2

| | traffic | | | drivable | other | | | | |
|---|---|---|---|---|---|---|---|---|---|
| | cone | trailer | truck | surface | flat | sidewalk | terrain | manmade | vegetation |
| BEV | 15.84 | 27.12 | 29.28 | 76.35 | 32.97 | 44.57 | 48.97 | 34.01 | 30.35 |
| Points | 15.43 | 26.92 | 32.04 | 71.42 | 35.96 | 42.65 | 41.92 | 30.61 | 30.26 |

Systems, apparatuses, methods (also referred to as processes), and computer-readable media (collectively referred to herein as “systems and techniques”) are described herein for generating three-dimensional (3D) occupancy data. For example, the systems and techniques described herein may combine the strengths of 2D BEV representations and point-based representations. Both 2D BEV representations and point-based representations are efficient representations. 2D BEV representations are good at capturing large surfaces. Point-based representations are good at capturing smaller and thin objects in 3D.

Additionally, the systems and techniques avoid the drawbacks of both 2D BEV representations and point-based representations. For example, the systems and techniques do not require a large number of points to represent large surfaces. The systems and techniques me achieve this by giving the right subset of classes in supervision. For example, the while training machine-learning models of the systems and techniques, the systems and techniques may train the machine-learning models with classes that may allow the machine-learning models to learn efficient ways to process and/or represent the classes.

Additionally or alternatively, the systems and techniques may use fewer points (compared to point-based representations) since the systems and techniques use points to model small objects. Reducing the number of points can reduce computation costs.

A hybrid representation (e.g., a hybrid between a 2D BEV representation and a point-based representation) may leverage the strengths of 2D BEV representations and point-based representations. For example, points may be used to represent classes that can benefit more from 3D modeling, and not large surfaces like road, sidewalk, and buildings. Representing such classes using points may require fewer points than representing large surfaces in using point-based representations.

Various aspects of the application will be described with respect to the figures below. Illustrative and non-limiting aspects and examples related to the present disclosure are included in Appendix A attached hereto, which is incorporated herein by reference in its entirety for all purposes.

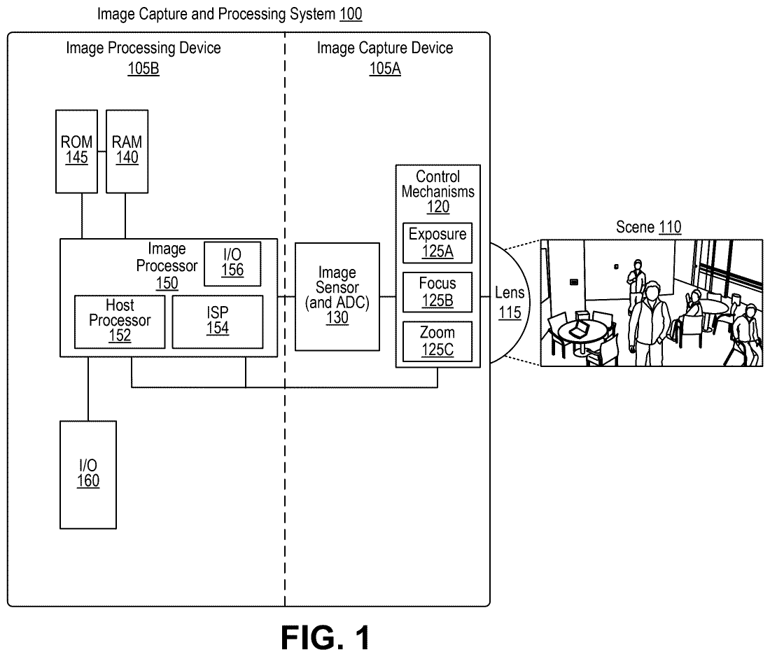

FIG. 1 is a block diagram illustrating an architecture of an image capture and processing system 100. The image capture and processing system 100 includes various components that are used to capture and process images of one or more scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130. In some examples, the scene 110 is a scene in an environment. In some examples, the scene 110 is a scene of at least a portion of a user. For instance, the scene 110 can be a scene of one or both of the user's eyes, and/or at least a portion of the user's face.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 1610 discussed with respect to the computing system 1600. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™ Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140 and/or 1620, read-only memory (ROM) 145 and/or 1625, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1635, any other input devices 1645, or some combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the system 100 and one or more peripheral devices, over which the system 100 may receive data from the one or more peripheral device and/or transmit data to the one or more peripheral devices. The I/O devices 160 may include one or more wireless transceivers that enable a wireless connection between the system 100 and one or more peripheral devices, over which the system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 1602.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

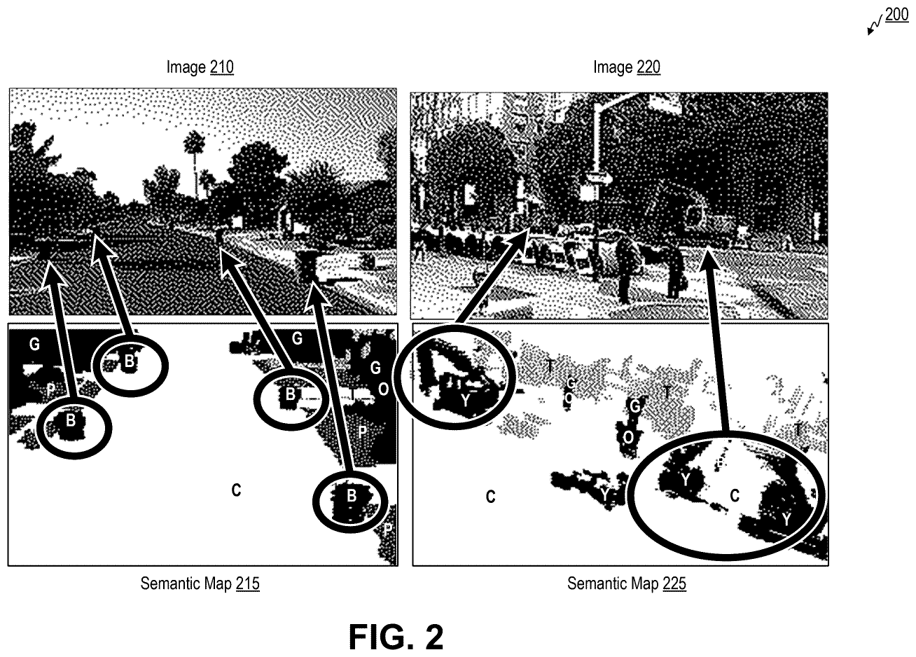

FIG. 2 is a conceptual diagram 200 illustrating examples of images (e.g., image 210, image 220) and corresponding semantic maps (e.g., semantic map 215, semantic map 225). Semantic maps can be used for object detection and/or object recognition, for instance to categorize objects in image(s) into object categories. For instance, the conceptual diagram 200 includes an image 210 of a suburban street on a trash pickup day, with trash bins and/or recycling bins at the edges of the street. The semantic map 215 categorizes the different pixels of the image 210 of the suburban street (or a similar image of the same scene from a slightly different perspective) into different object categories. For instance, in the semantic map 215, cyan (labeled “C”) represents the asphalt and/or concrete (e.g., the street, sidewalks, and/or driveways), green (labeled “G”) represents plants (e.g., trees, bushes, and/or other plants), purple (labeled “P”) represents dirt and/or grass, tan (labeled “T”) represents structures (e.g., man-made structures such as buildings or houses or fences), orange (labeled “O”) represents tree trunks, and black (labeled “B”) represents out-of-vocabulary objects (also known as unlabeled objects). The trash bins and/or recycling bins at the edges of the street in the image 210 are out-of-vocabulary objects and therefore represented as black blobs in the semantic map 215. In some examples, a different color scheme may be used, with different colors representing different categories of objects and/or occupancy states.

The image 220 depicts an urban scene with streets between tall buildings, construction barriers, and construction vehicles such as an excavator with an excavator bucket at the end of an excavator arm (e.g., with a boom and dipper). The semantic map 225 categorizes the different pixels of the image 220 of the urban scene (or a similar image of the same scene from a slightly different perspective) into different object categories. For instance, in the semantic map 225, cyan (labeled “C”) represents the asphalt and/or concrete (e.g., the street and/or sidewalks), green (labeled “G”) represents plants (e.g., trees, bushes, and/or other plants), yellow (labeled “Y”) represents construction vehicles and/or equipment, tan (labeled “T”) represents structures (e.g., man-made structures such as buildings or houses or fences), orange (labeled “O”) represents tree trunks, and blue (labeled “B”) represents people. For instance, the excavators in the image 220 are mostly mapped to the color yellow in the semantic map 225, indicating that they are construction vehicles and/or equipment. However, portions of the arm of the excavator are incorrectly mapped to the color cyan (indicating asphalt and/or concrete) rather than the color yellow (indicating construction vehicles and/or equipment) due to the unusual shape of the excavator arm. In some examples, a different color scheme may be used, with different colors representing different categories of objects and/or occupancy states.

3D perception may be important for vision-based robotic systems such as autonomous driving. 3D perception can include 3D object detection. In some examples, 3D object detection estimates 3D locations and dimensions (e.g., via bounding boxes) of objects in pre-determined object classes. For instance, each object can be classified via one or more bounding boxes. In some examples, different parts of a larger object can be bound by their own bounding box to represent objects that are non-rectangular in shape. However, while bounding box representations are compact, the level of expressiveness (and/or level of accuracy) can be restricted.

3D bounding box representations of objects have a number of limitations. For instance, 3D bounding box representations can have issues with dealing with out-of-vocabulary objects. For instance, the trash bins and/or recycling bins at the edges of the street in the image 210 are out-of-vocabulary objects and therefore represented as black blobs in the semantic map 215. In some classification systems, out-of-vocabulary objects are treated as unobserved areas and are essentially ignored. This can be problematic. For instance, if a 3D perception is used to route a vehicle (e.g., a self-driving autonomous vehicle), it would be dangerous for the vehicle to hit any object, including out-of-vocabulary objects such as the trash bins and/or recycling bins at the edges of the street in the image 210. The systems and methods described further herein improve over such systems by identifying and/or predicting which volumes in a 3D environment are occupied or unoccupied (free), so that even if a specific volume has an out-of-vocabulary object (e.g., the trash bins and/or recycling bins), the specific volume is still labeled as occupied if there is a physical object occupying the specific volume or unoccupied (free) if there is no physical object occupying the specific volume.

Another limitation of 3D bounding box representations of objects can be erasure of geometric details of certain objects. Bounding boxes can fail to accurately represents geometry of irregularly-shaped objects (e.g., objects that are not rectangular). For instance, in the semantic map 225, portions of the arm of the excavator (visible in the image 220) are incorrectly mapped to the color cyan (indicating asphalt and/or concrete) rather than the color yellow (indicating construction vehicles and/or equipment) due to the unusual shape of the excavator arm. This can be problematic. For instance, if a 3D perception is used to route a vehicle (e.g., a self-driving autonomous vehicle), it would be dangerous for the vehicle to hit any portion of any object, regardless of the geometry of the object, including objects with irregular geometry such as the arm of the excavator in the image 210. The systems and methods described further herein improve over such systems by modeling objects using voxel-based object detection and mapping. In some examples, the voxel-based object detection and mapping is performed using trained machine learning (ML) model(s) that are trained through multi-modal supervision (e.g., along with ML model(s) that generate depth maps and/or semantic maps).

Another limitation of 3D bounding box representations of objects can be ineffective representation of large objects, such as surfaces of roads. The systems and methods described further herein improve over such systems by modeling objects using voxel-based object detection and mapping.

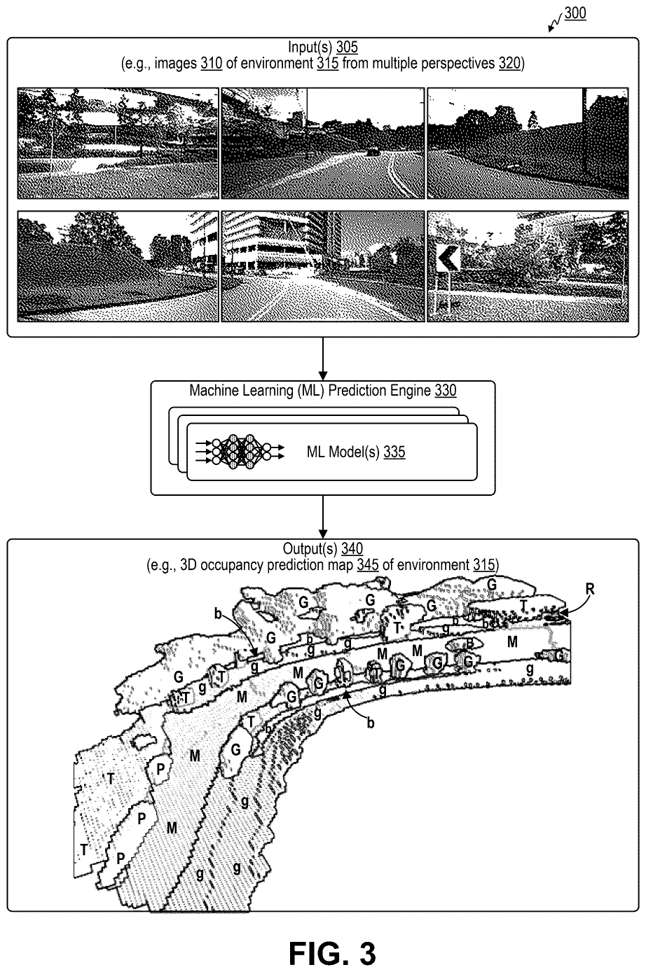

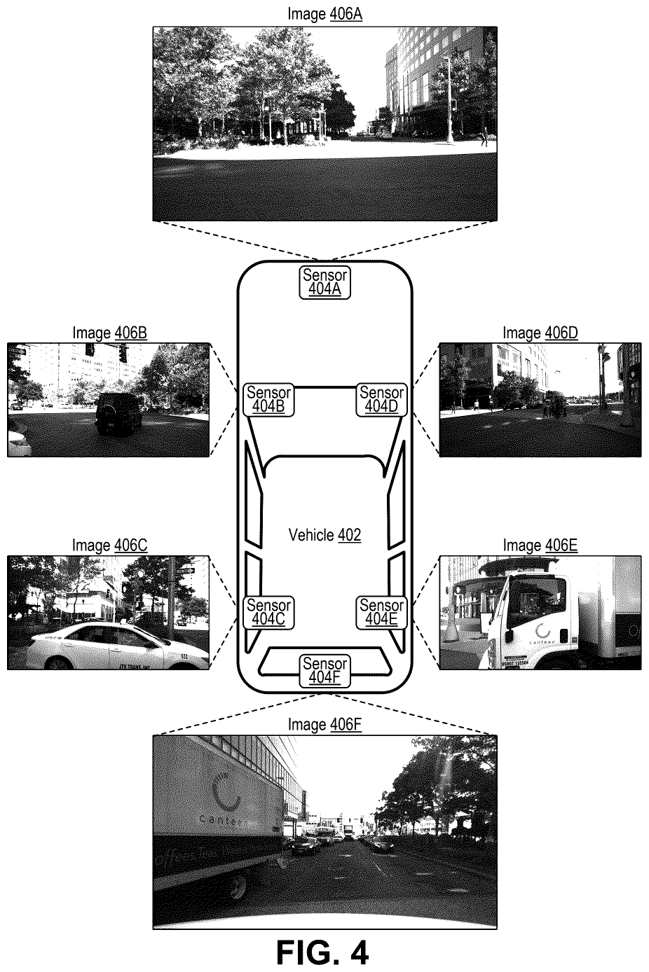

FIG. 3 is a block diagram illustrating an imaging system 300 that processes images 310 of an environment 315 using ML model(s) 335 to generate a 3D occupancy prediction map 345 of the environment 315. The imaging system 300 can include a ML prediction engine 330 that includes one or more ML model(s) 335 that receive and process input(s) 305 to generate output(s) 340. The input(s) 305 can include images 310 of an environment 315 taken from multiple perspectives 320. In some examples, the images 310 can be captured by different cameras (and/or other sensors) that are coupled to a vehicle and that have different poses (e.g., coupled to the vehicle at different positions, having different orientations and therefore facing different directions, or a combination thereof). The cameras can be examples of the image capture and processing system 100 and/or the image capture device 105A, or vice versa. The different perspectives 320 can correspond to the different poses of the different cameras and/or other sensors. For instance, FIG. 4 illustrates a vehicle 402 with multiple sensors sensor 404A to 404F that are coupled to the vehicle 402 at different positions and that capture images 406A to 406F having different perspectives (e.g., the perspectives 320).

The output(s) 340 include a 3D occupancy prediction map 345 of the environment 315, which the ML model(s) 335 generate based on the input(s) 305 (e.g., based on the images 310). In some examples, the ML model(s) 335 can be trained to generate the 3D occupancy prediction map 345 of the environment 315 to model the detailed geometry and semantics of objects, for objects that are in-vocabulary and for objects that are out-of-vocabulary. The 3D occupancy prediction map 345 of the environment 315 includes a representation and categorization of every voxel in the 3D space of the environment 315. In some examples, the ML model(s) 335 can be trained to generate the 3D occupancy prediction map 345 of the environment 315 jointly estimate the occupancy state and semantic label of each voxel in the environment 315 from the input(s) 305 (e.g., the images 310 of the environment 315). For instance, the ML model(s) 335 can generate the 3D occupancy prediction map 345 of the environment 315 so that each voxel is labeled as occupied (e.g., by a solid material, a liquid material, and/or another physical object), free (e.g., unoccupied, or just occupied by gas, such as air), or unobserved (e.g., not pictured in any of the images 310 or any other input(s) 305).

In some examples, the ML model(s) 335 can generate the 3D occupancy prediction map 345 of the environment 315 so that each voxel is also labeled with an object type. For instance, in the 3D occupancy prediction map 345 illustrated in FIG. 3, voxels colored in magenta (labeled “M”) represent drivable surfaces (e.g., asphalt), voxels colored in light green (labeled “g”) represent terrain (e.g., grass or dirt), voxels colored in dark green (labeled “G”) represent vegetation (e.g., trees, bushes), voxels colored in tan (labeled “T”) represent structures (e.g., buildings or other man-made structures), voxels colored in blue (labeled “B”) represent cars, voxels colored in purple (labeled “P”) represent trucks, voxels colored in red (labeled “R”) represent people (e.g., pedestrians), and voxels colored in brown (labeled “b”) represent non-vehicle paths (e.g., hiking trails, biking trails, sidewalks). In some examples, a different color scheme may be used, with different colors representing different categories of objects and/or occupancy states. In some examples, certain colors may represent other categories of objects, such as barriers, bicycles, buses, trains, construction vehicles, motorcycles, traffic cones, trailers, other flat surfaces, unobserved areas, and/or out-of-vocabulary objects. In the 3D occupancy prediction map 345, the out-of-vocabulary objects are considered general objects (GO)—that is, occupied, but without a semantic label as to object type that is more specific than being occupied.

In some examples, the ML model(s) 335 can generate other output(s) 340 (instead of or in addition to the 3D occupancy prediction map 345) based on the input(s) 305. For instance, the output(s) 340 can include two-dimensional (2D) depth maps of the environment 315 from the perspectives 320 and/or 2D semantic maps of the environment 315 from the perspectives 320.

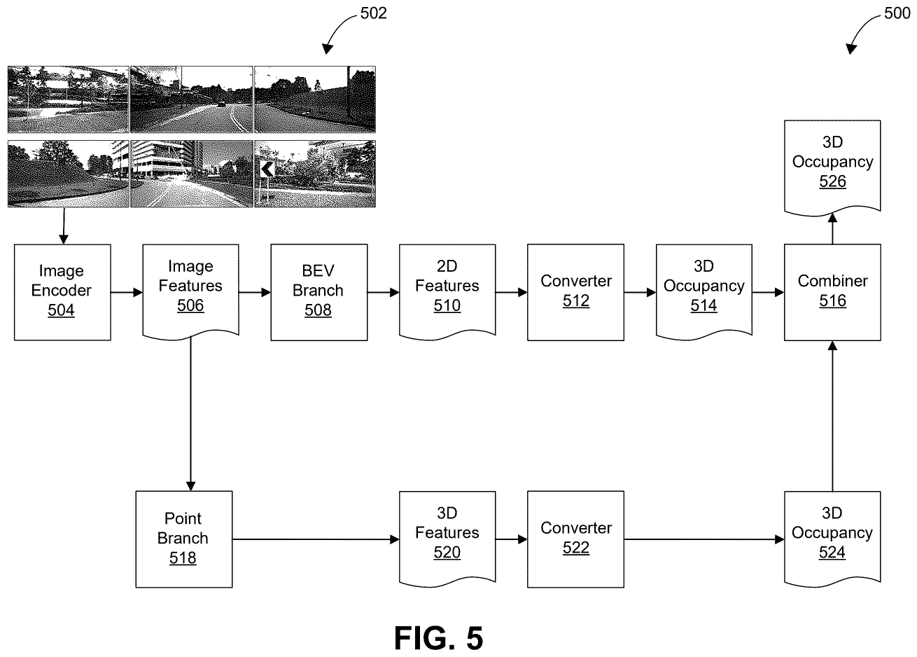

In some examples, the ML model(s) 335 can generate the output(s) 340 based on other input(s) 305 (instead of or in addition to the images 310). For instance, the input(s) 305 can include metadata associated with the images 310 (e.g., indicating which camera each of the images 310 is captured by and a pose of the camera), depth maps, semantic maps (e.g., 2D semantic map 225), surface normals (e.g., surface normal 535), local planar priors (e.g., local planar prior 550), edge priors (e.g., edge prior 565), depth data such as point clouds (e.g., captured using a depth sensor such as radio detection and ranging (RADAR), light detection and ranging (LiDAR), sound detection and ranging (SODAR), sound navigation and ranging (SONAR), time of flight (ToF) sensors, structured light sensors), any of the types of input(s) illustrated in FIG. 5, any of the types of input(s) discussed herein, or a combination thereof.

Use of the ML model(s) 335 to automatically generate a 3D occupancy prediction map 345 can enable real-time or near-real-time use of the 3D occupancy prediction map 345 for tasks such as routing of an autonomous vehicle. Annotation (e.g., semantic labeling) of image data can take a significant amount of time to perform manually. For instance, in some examples, annotating 30,000 frames of images manually can take 40,000 hours for a person to do manually. The slow pace of manual annotation (e.g., semantic labeling) of image data is incompatible with certain tasks, such as routing of an autonomous vehicle, where a vehicle needs to know what to do at a certain point before the vehicle arrives at that point. This is especially true for cameras with high frame rates (e.g., 60 fps, 90 fps, 120 fps, 240 fps) and/or high resolutions (e.g., 2K, 4K, 8K). Furthermore, manual annotation (e.g., semantic labeling) of image data can result in ambiguous or inconsistent labeling, as different people might label or categorize different objects in slightly different ways. On the other hand, the ML model(s) 335 can be trained to consistently and unambiguously determine both an occupancy state (e.g., occupied, free, or unobserved) and a semantic label (e.g., street, plant, vehicle, building, construction equipment, water, person, bicyclist, and/or general objects) for each voxel of the 3D occupancy prediction map 345.

FIG. 4 illustrates a vehicle 402 with multiple sensors (e.g., sensors 404A to 404F) that are coupled to the vehicle 402 at different positions and that capture images 406A to 406F having different perspectives (e.g., perspectives 320).

FIG. 5 is a block diagram illustrating an example system 500 for generating 3D occupancy data 526, according to various aspects of the present disclosure. In general, an image encoder 504 may process images 502 to generate image features 506. A BEV branch 508 may process image features 506 to generate 2D features 510. A converter 512 may process 2D features 510 to generate 3D occupancy 514. Additionally, a point branch 518 may process image features 506 to generate 3D features 520. A converter 522 may process 3D features 520 to generate 3D occupancy 524. A combiner 516 may combine 3D occupancy 514 and 3D occupancy 524 to generate 3D occupancy data 526. Conceptually, occupancy prediction may include: 1) predicting whether a 3D location (e.g., a voxel) is occupied by an object or not (e.g., whether the 3D location includes a vehicle, a pedestrian, the ground etc. or air), and 2) predicting if a given 3D location is occupied, what is the semantic class of the object occupying the location (e.g., vehicle, pedestrian, ground, etc.). As such, 3D occupancy 514, 3D occupancy 524, and 3D occupancy data 526 may include a voxel-based representation of a 3D space including indications whether each voxel of the 3D space is occupied or not and, for each occupied voxel, 3D occupancy 514, 3D occupancy 524, and 3D occupancy data 526 may include a respective semantic label. 3D occupancy 514, 3D occupancy 524, and 3D occupancy data 526 may be substantially similar to occupancy prediction map 345 of FIG. 3

Images 502 are example images of an environment that may be captured by one or more cameras. Images 502 may be captured at substantially the same time. Images 502 may be captured by separate cameras pointed in different directions. For example, images 502 may be examples of image 406A to 406F as captured by sensor 404A to 404F.

Image encoder 504 may be, or may include, a machine-learning model trained to generate image features based on images. For example, image encoder 504 may be, or may include, a convolutional neural network (CNN).

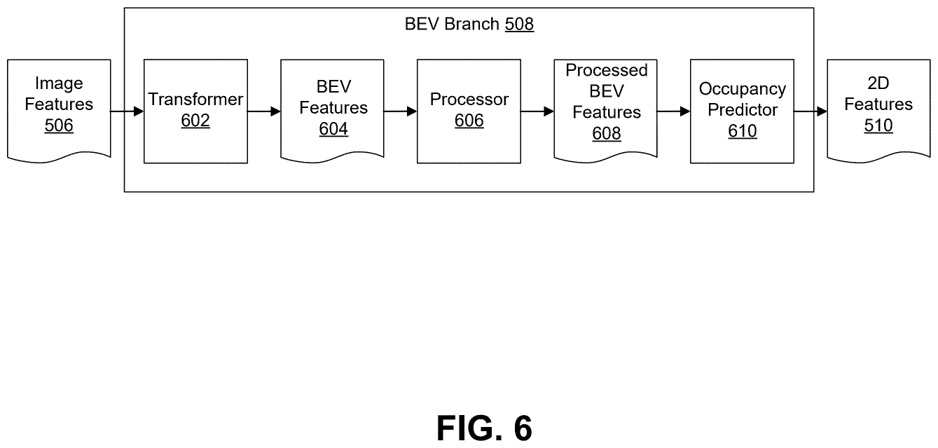

BEV branch 508 may detect object in a 2D BEV space. BEV branch 508 may be, or may include, one or more machine-learning models trained to detect objects based on image features. Additional detail regarding BEV branch 508 is provided with regard to FIG. 6.

2D features 510 may be, or may include, feature-space representations of indications of object detections in a 2D BEV space. 2D features 510 may represent, in feature space, position information (e.g., in a 2D BEV space) and labels. For example, 2D features 510 may represent, in feature space, positions of vehicles, pedestrians, motorcycles, bicycles, buildings, trees, sidewalks, intersections, crosswalks, etc. detected in images 502 and labels indicating classes of the detected objects.

Converter 512 may convert 2D features 510 into a 3D space to generate 3D occupancy 514. For example, converter 512 may decode and unproject 2D features 510 into the 3D space to generate 3D occupancy 514. 3D occupancy 514 may be substantially similar to occupancy prediction map 345 of FIG. 3. For example, converter 512 may be, or may include, a voxel representation of a 3D space including a plurality of voxels that may have states such as occupied, vacant, or unobserved. Occupied voxels may further have semantic labels indicative of an object occupying the voxel.

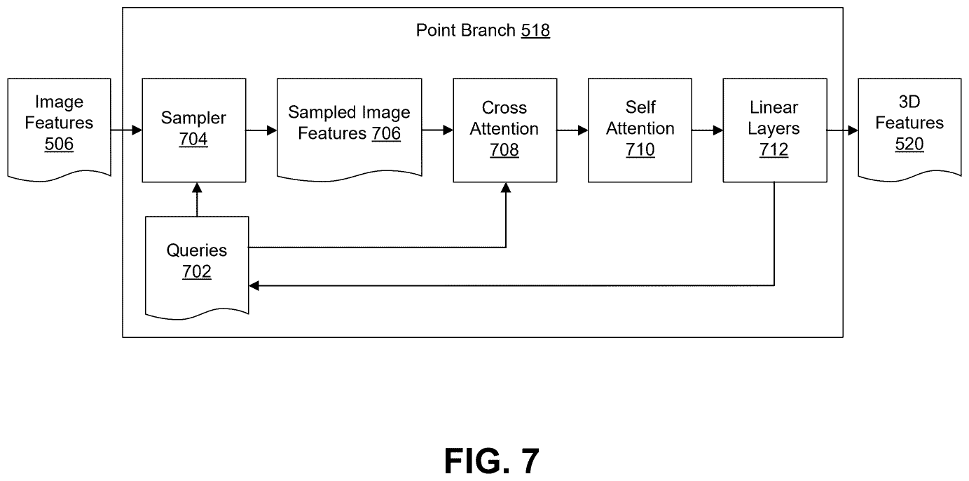

Point branch 518 may detect object in a 3D space. Point branch 518 may be, or may include, one or more machine-learning models trained to detect objects based on image features. Additional detail regarding point branch 518 is provided with regard to FIG. 7.

Converter 522 may convert 3D features 520 into 3D occupancy 524. In general, converter 522 may convert 3D point features (including both position information and semantic information) to 3D volume. The 3D points can be in any place in 3D, while the 3D volume is a regular data format-regular grids in 3D, e.g., length×width×height.

Combiner 516 may combine 3D occupancy 514 with 3D occupancy 524 to generate 3D occupancy data 526. For example, combiner 516 may add 3D object detections of 3D occupancy 514 and 3D object detections of 3D occupancy 524 into a common 3D space. 3D occupancy 524 may be substantially similar to occupancy prediction map 345 of FIG. 3.

3D occupancy data 526 may be, or may include, a 3D representation of the environment depicted in images 502. 3D occupancy data 526 may include a plurality of voxels. Each of the voxels may be classified as one of occupied, unoccupied, or unobserved. Each occupied voxel may be labeled with an object label. 3D occupancy data 526 may be an example of occupancy prediction map 345 of FIG. 3.

During a training phase of operation, system 500 may train one or more elements of system 500 (e.g., BEV branch 508 and/or point branch 518). The one or more elements may be trained according to a supervised, iterative backpropagation process. For example, system 500 may have obtain training data including training input images and corresponding ground-truth 3D occupancy data. System 500 may generate provisional 3D occupancy data based on the training input images. The provisional 3D occupancy data may be compared with ground-truth occupancy data. An error may be determined based on differences between the provisional 3D occupancy data and the ground-truth occupancy data. Parameters (e.g., weights) of elements of (e.g., BEV branch 508 and/or point branch 518) may be adjusted based on the error such that in successive iterations of the training process, further instances of the provisional occupancy data may be more similar to the ground-truth occupancy data.

System 500 may output 3D occupancy data 526. One or more downstream applications may use 3D occupancy data 526. For example, a driving system may make determinations regarding steering, braking, accelerating, path planning, based on 3D occupancy data 526.

FIG. 6 is a block diagram illustrating an example implementation of BEV branch 508 of FIG. 5 to provide additional detail regarding BEV branch 508, according to various aspects of the present disclosure. Transformer 602 may transform image features 506 into a BEV space to generate BEV features 604. Transformer 602 may be, or may include, a machine-learning model trained to transform image features based on images captured from separate perspectives into a common BEV space. Transformer 602 may, for example, implement a lift, splat, shoot, (LSS) encoding technique.

Processor 606 may process BEV features 604 to generate processed BEV features 608. Processor 606 may be, or may include, an encoder to encode BEV features 604 into a feature space to generate processed BEV features 608. Processor 606 may be, or may include, one or more machine-learning models. For example, processor 606 may include one or more convolutional layers. As another example, processor 606 may include a transformer (which may include multiple layers).

Occupancy predictor 610 may generate 2D features 510 based on processed BEV features 608. For example, occupancy predictor 610 may predict an occupancy of 2D cells of a 2D BEV space based on processed BEV features 608. Occupancy predictor 610 may be, or may include, one or more machine-learning models trained to detect objects and generate a 2D BEV map of cells based on BEV features.

As described above, BEV branch 508 may be trained as part of system 500 through a supervised, iterative backpropagation process. Through the training process, parameters (e.g., weights) of transformer 602, processor 606, and/or occupancy predictor 610 may be adjusted to improve, through the iterative process, 2D features 510 generated by BEV branch 508.

In some aspects, BEV branch 508 may be trained separately from and/or independent of point branch 518. For example, in some aspects, the training process may involve comparing ground-truth 3D detections to provisional instances of 3D occupancy 514 and adjusting parameters (e.g., weights) of BEV branch 508 based on the comparison.

FIG. 7 is a block diagram illustrating an example implementation of point branch 518 of FIG. 5 to provide additional detail regarding point branch 518, according to various aspects of the present disclosure. Point branch 518 may include a number of layers (e.g., layers of a transformer network). Cross attention 708, self attention 710, and linear layers 712 are provided as example layers.

Point branch 518 may initialize queries 702. In some aspects, point branch 518 may randomly initialize queries 702, for example, point branch 518 may initialize queries 702 with random values. Queries 702 may include 3D points (e.g., coordinates) and feature vectors. For example, each query of queries 702 may include 3D coordinates and a vector of feature values.

Sampler 704 may sample image features 506 and queries 702 to generate sampled image features 706.

Cross attention 708 is an example cross-attention layer that may apply attention to sampled image features 706 (or to an output of another layer). For example, cross attention 708 may use sampled image features 706 as keys and values and use queries 702 as queries.

Self attention 710 is an example of a self-attention layer that may apply self attention to sampled image features 706 (or to an output of cross attention 708 or an output of another layer).

Linear layers 712 is an example of a linear layer that may perform one or more linear operations on sampled image features 706 (or an output of a prior layer, such as self attention 710).

Collectively, one or more instances of cross attention 708, one or more instances of self attention 710, and/or one or more instances of linear layers 712 may iteratively refine queries 702 to generate 3D features 520 based on image features 506. In some aspects, point branch 518 may perform operations that are the same as, or substantially similar to the operations described by “OPUS: Occupancy Prediction Using a Sparse Set” by Jiabao Wang, Zhaojiang Liu, Qiang Meng, Liujiang Yan, Ke Wang, Jie Yang, Wei Liu, Qibin Hou, and Ming-Ming Cheng, published in 38th Conference on Neural Information Processing (NeurIPS 2024), available at https://www.arxiv.org/pdf/2409.09350, which is incorporated by reference, in its entirety, for all purposes.

As described above, point branch 518 may be trained as part of system 500 through a supervised, iterative backpropagation process. Through the training process, parameters (e.g., weights) of cross attention 708, self attention 710, and/or linear layers 712 may be adjusted to improve, through the iterative process, 3D features 520 generated by point branch 518.

In some aspects, point branch 518 may be trained separately from and/or independent of BEV branch 508. For example, in some aspects, the training process may involve comparing ground-truth 3D detections to provisional instances of 3D occupancy 524 and adjusting parameters (e.g., weights) of point branch 518 based on the comparison.

In some aspects, point branch 518 may be trained on a subset of the ground-truth training data used to train system 500. For example, the ground-truth data used to train system 500 (e.g., to train BEV branch 508 and point branch 518) may include classifications of objects. In some aspects, point branch 518 may be trained to detect a subset of the objects. For example, point branch 518 may be trained using a subset of the ground-truth data. For instance, point branch 518 may be suited to detecting small objects, such as bicycles, motorcycles, and pedestrians. Point branch 518 may be trained with ground-truth training data including objects classified as bicycles, motorcycles, and pedestrians (e.g., and not data of other classes such as cars, buildings, etc.).

For instance, during training, provisional instances of 3D occupancy 514 may be compared to all classes of ground-truth data to determine errors and to iteratively adjust parameters of BEV branch 508. During the training, provisional instances of 3D occupancy 524 may be compared to a subset of classes of the ground-truth data to determine errors and to iteratively adjust parameters of point branch 518. Further, during the training, provisional instances of 3D occupancy data 526 may be compared to all classes of ground-truth data to determine errors and to iteratively adjust parameters of BEV branch 508 and point branch 518.

The subset of classes of the ground-truth data used to train point branch 518 may be selected based on classes of objects for which BEV branch 508 performs poorly (e.g., below a detection-accuracy threshold). Additionally or alternatively, the classes may be selected heuristically. For example, point branch 518 may be trained on classes including: bicycle, construction vehicle, motorcycle, pedestrian, traffic cone, other, and other-flat objects.

Supervising points with a small subset of classes that benefit more from 3D learning. For example, classes can be selected based on human knowledge of the shape and/or size of objects. For instance, bicycles may not be well suited to be represented in 2D BEV representations and be better modeled when there is a vertical axis. Classes can be selected based on the number of points capturing them in a dataset, (e.g., bicycles may be represented by relatively few points in light detection and ranging (LIDAR) point clouds data sets).

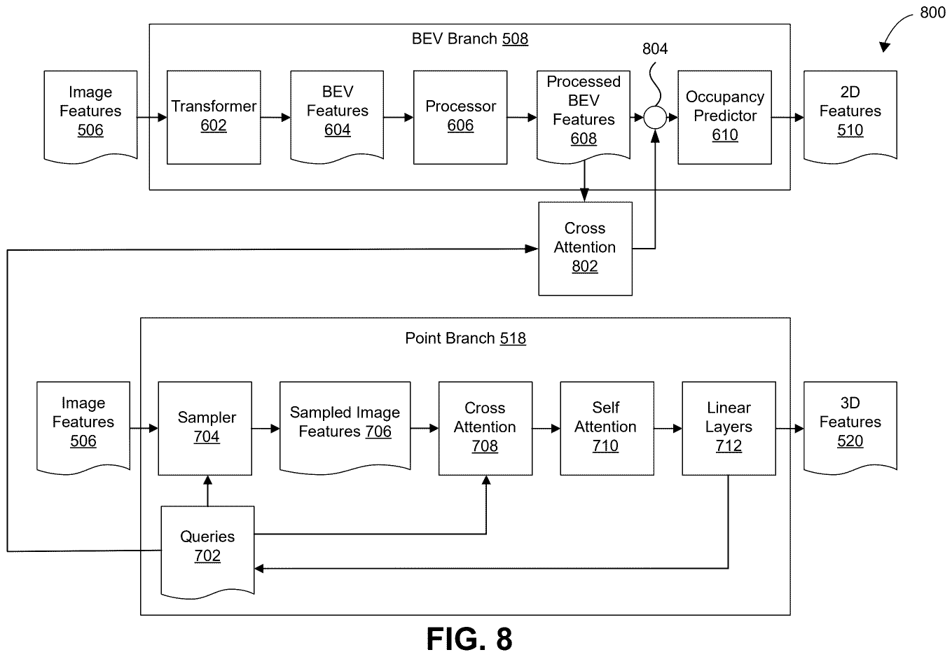

FIG. 8 is a block diagram illustrating an example system 800 for generating 3D occupancy data, according to various aspects of the present disclosure. In general, an image encoder (such as image encoder 504, which is not illustrated in FIG. 8) may process images (such as images 502, which are not illustrated in FIG. 8) to generate image features 506. A BEV branch 508 may process image features 506 to generate 2D features 510. Additionally, a point branch 518 may process image features 506 to generate 3D features 520.

In some aspects, a converter (such as converter 512, which is not illustrated in FIG. 8) may process 2D features 510 to generate 3D detections (such as 3D occupancy 514, which are not illustrated in FIG. 8). A converter (such as converter 522, which is not illustrated in FIG. 8) may process 3D features 520 to generate 3D detections (such as 3D occupancy 524, which is not illustrated in FIG. 8). A combiner (such as combiner 516, which is not illustrated in FIG. 8) may combine the 3D detections based on 2D features 510 and the 3D detections based on 3D features 520 to generate the 3D occupancy data.

System 800 may be substantially similar to system 500 of FIG. 5. BEV branch 508 may be substantially similar to BEV branch 508 as illustrated and described with regard to FIG. 6. point branch 518 may be substantially similar to point branch 518 as described with regard to FIG. 7.

Additionally, system 800 includes a cross attention 802 and BEV branch 508 includes a combiner 804. Cross attention 802 may perform cross-attention operations on queries 702 and processed BEV features 608. Cross attention 802 may use queries 702 as keys and values and processed BEV features 608 as queries. Combiner 804 may combine (e.g., concatenate) an output of cross attention 802 with processed BEV features 608 and occupancy predictor 610 may predict 2D features 510 based on processed BEV features 608 combined with the outputs of cross attention 802.

System 800 includes a more sophisticated interaction between BEV branch 508 and point branch 518 than is included in system 500. Cross attention 802 provides cross-attention between BEV features (e.g., processed BEV features 608) and queries from point branch 518 (e.g., queries 702). Processed BEV features 608 acts as queries and queries 702 act as keys and values in cross attention 802.

In system 800, cross attention 802 illustrates interactions between queries 702 and processed BEV features 608. In other aspects, BEV feature from any layer of 2D processing in BEV branch 508 can cross-attend point queries from any layer in the point branch 518.

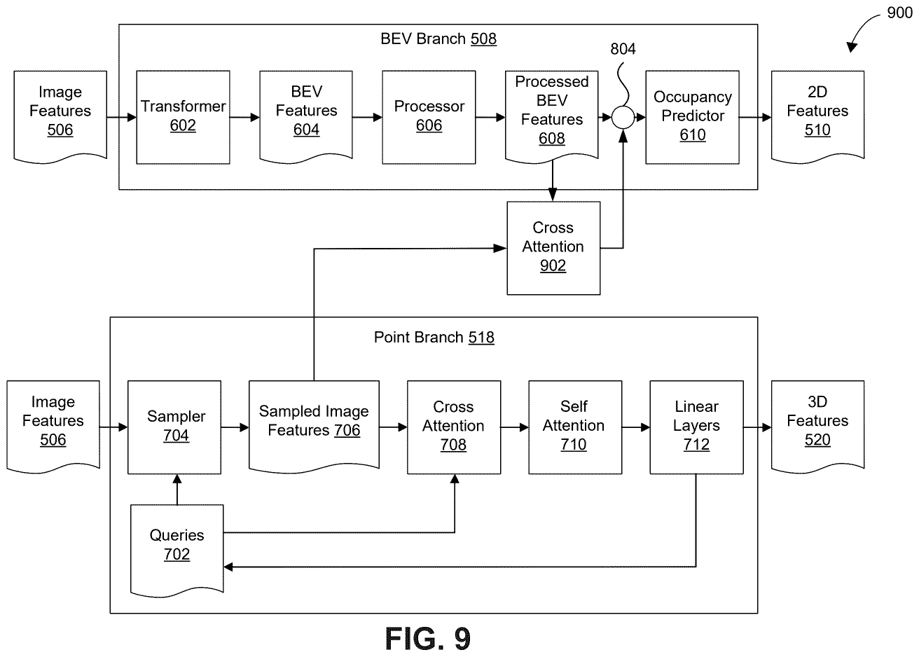

FIG. 9 is a block diagram illustrating an example system 900 for generating 3D occupancy data, according to various aspects of the present disclosure. System 900 may be substantially similar to system 800 of FIG. 8. However, whereas in system 800, cross attention 802 performs cross-attention operations using queries 702 as keys and values and processed BEV features 608 as queries, in system 900, cross attention 902 may performs cross-attention operations using sampled image features 706 as keys and values and processed BEV features 608 as queries.

Similar to system 800, system 900 includes a more sophisticated interaction between BEV branch 508 and point branch 518 than is included in system 500. Cross attention 902 provides cross-attention between BEV features (e.g., processed BEV features 608) and sampled point features from camera views (e.g., sampled image features 706). Processed BEV features 608 act as queries and sampled image features 706 act as keys and values.

In system 900, cross attention 902 illustrates interactions between sampled image features 706 and processed BEV features 608. BEV feature from any layer of 2D processing in BEV branch 508 can cross-attend sampled point features from any layer in the point branch 518.

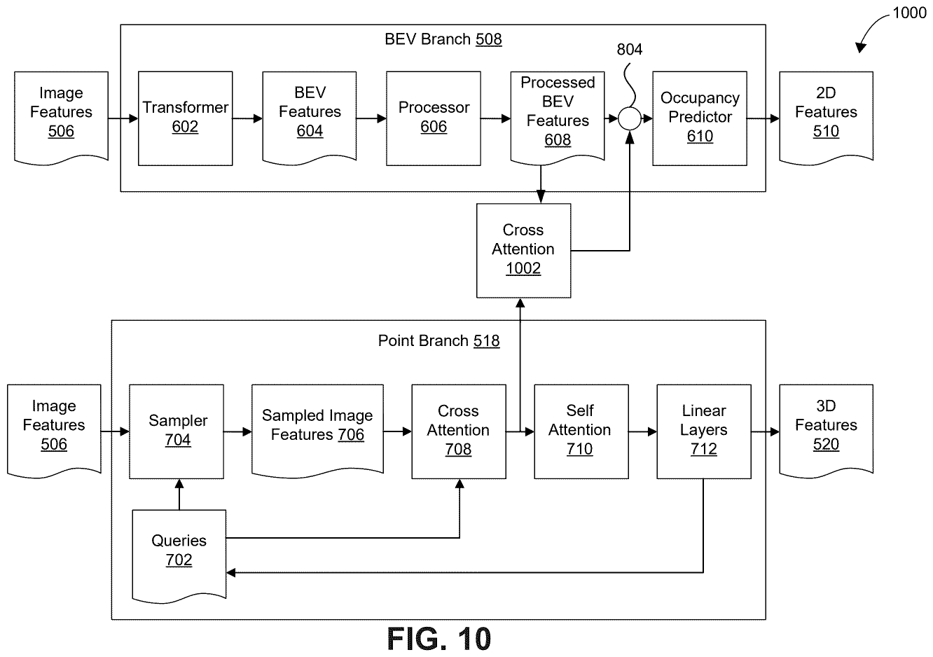

FIG. 10 is a block diagram illustrating an example system 1000 for generating 3D occupancy data, according to various aspects of the present disclosure. System 1000 may be substantially similar to system 800 of FIG. 8. However, whereas in system 800, cross attention 802 performs cross-attention operations using queries 702 as keys and values and processed BEV features 608 as queries, in system 1000, cross attention 1002 may performs cross-attention operations using an output of cross attention 708 (e.g., a cross-attention layer of point branch 518) as keys and values and processed BEV features 608 as queries.

Similar to system 800, system 1000 includes a more sophisticated interaction between BEV branch 508 and point branch 518 than is included in system 500. Cross attention 1002 provides cross-attention between BEV features (e.g., processed BEV features 608) and query-camera fused features in point branch (e.g., outputs of cross attention 708). Query-camera fused features can come from the output of cross attention 708 in a layer in the point branch. Processed BEV features 608 act as queries and point-camera fused queries (e.g., outputs of cross attention 708) act as keys and values.

In system 1000, cross attention 1002 illustrates interactions between an output of cross attention 708 and processed BEV features 608. BEV feature from any layer of 2D processing in BEV branch 508 can cross-attend fused queries from any layer in the point branch 518.

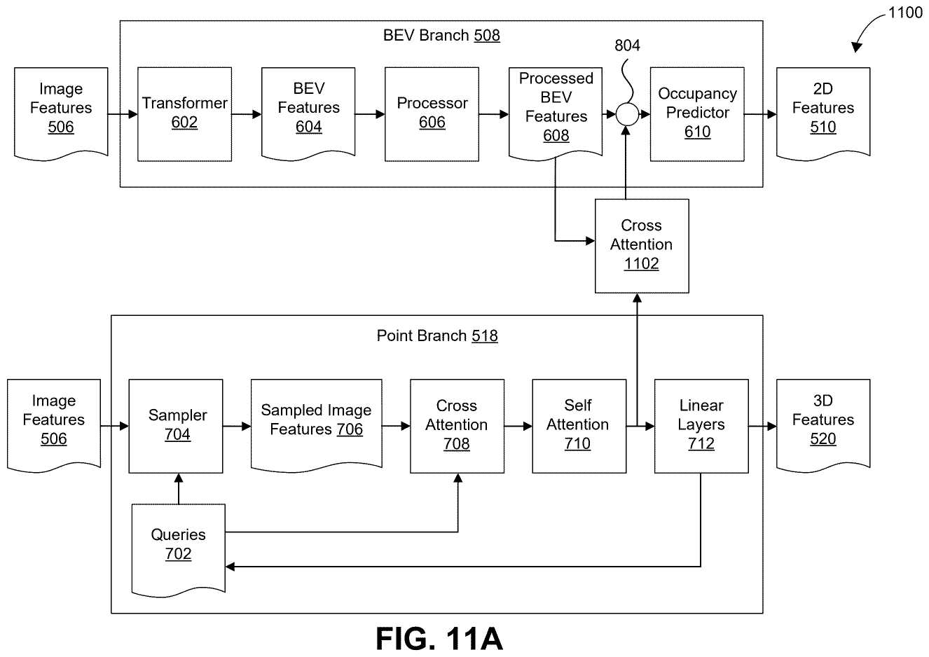

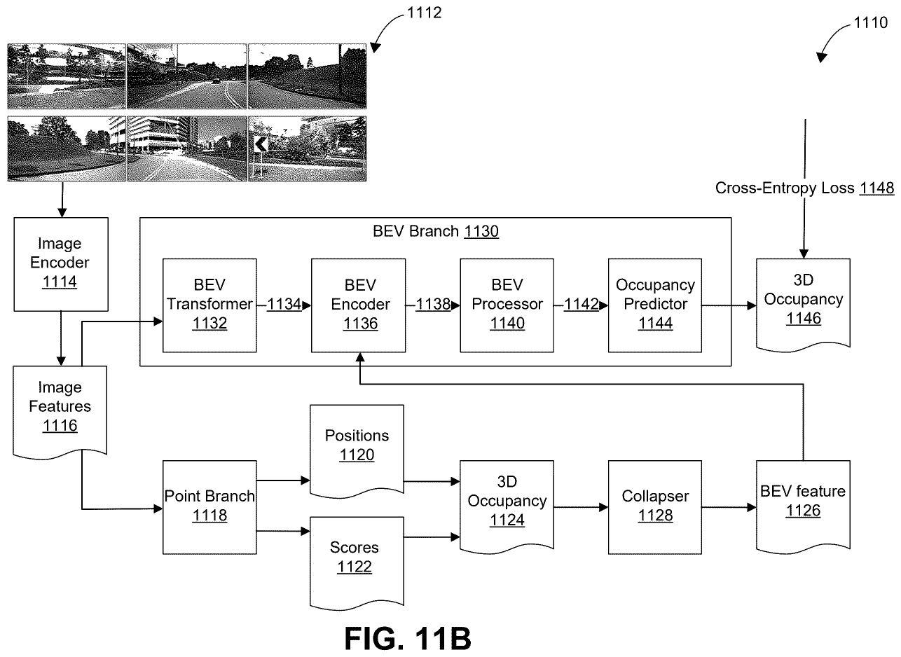

FIG. 11A is a block diagram illustrating an example system 1100 for generating 3D occupancy data, according to various aspects of the present disclosure. System 1100 may be substantially similar to system 800 of FIG. 8. However, whereas in system 800, cross attention 802 performs cross-attention operations using queries 702 as keys and values and processed BEV features 608 as queries, in system 1100, cross attention 1102 may performs cross-attention operations using an output of self attention 710 (e.g., a self-attention layer of point branch 518) as keys and values and processed BEV features 608 as queries.

Similar to system 800, system 1100 includes a more sophisticated interaction between BEV branch 508 and point branch 518 than is included in system 500. Cross attention 1102 provides cross-attention between BEV features (e.g., processed BEV features 608) and query-camera fused features in point branch (e.g., outputs of self attention 710). Query-camera fused features can come from the output of self attention 710 in a layer in the point branch. Processed BEV features 608 act as queries and point-camera fused queries (e.g., outputs of self attention 710) act as keys and values.

In system 1100, cross attention 1102 illustrates interactions between an output of self attention 710 and processed BEV features 608. BEV feature from any layer of 2D processing in BEV branch 508 can cross-attend fused queries from any layer in the point branch 518.

In general, BEV features (e.g., processed BEV features 608) act as query to get object/foreground features from point branch. This is because point branch learns stronger signals corresponding to objects less well learned in BEV. By doing this, system 800, system 900, system 1000, and system 1100 can enhance these signals in the BEV branch.

System 500 is an example of fusion between BEV occupancy prediction (e.g., 2D features 510) and query/point-based occupancy prediction (e.g., 3D features 520). System 800, system 900, system 1000, and system 1100, are examples of late fusions between BEV occupancy predictions and query/point-based occupancy predictions.

FIG. 11B is a block diagram illustrating an example system 1110 for generating 3D occupancy data, according to various aspects of the present disclosure. In general, system 1110 may collapse a 3D volume (e.g., 3D occupancy 1124) generated by a point branch (e.g., point branch 1118) into a BEV feature (e.g., BEV feature 1126) and feed the collapsed BEV features (e.g., BEV feature 1126) into a BEV encoder (e.g., BEV encoder 1136) in a BEV branch (e.g., BEV branch 1130) to facilitate end-to-end occupancy learning.

Images 1112 may be the same as, or may be substantially similar to, images 502 of FIG. 5. Image encoder 1114 may be the same as, may be substantially similar to, and/or may perform the same, or substantially the same, operations as image encoder 504 of FIG. 5. Image features 1116 may be the same as, or may be substantially similar to, image features 506 of FIG. 5.

Point branch 1118 may be the same as, may be substantially similar to, and/or may perform the same, or substantially the same, operations as point branch 518 of FIG. 5 and FIG. 7. Additionally, positions 1120 and/or scores 1122 may be extracted from, or output by point branch 1118. In some aspects, point branch 1118 may be trained based on losses based on positions 1120 and/or scores 1122. Positions 1120 may be, or may include, 3D coordinates of the points Scores 1122 may be, or may include, point-wise predicted probabilities over the set of semantic classes.

Additionally, point branch 1118 may generate 3D occupancy 1124. 3D occupancy 1124 may be the same as, or may be substantially similar to, 3D features 520 of FIG. 5 and FIG. 7. Additionally or alternatively, 3D occupancy 1124 may be based on positions 1120 and/or scores 1122. For example, the 3D positions (e.g., positions 1120) and the point-wise predictions over the set of classes (e.g., scores 1122) can be converted into a 3D volume, as a form of 3D occupancy prediction (e.g., 3D occupancy 1124).

Collapser 1128 may collapse 3D occupancy 1124 to generate BEV feature 1126. For example, collapser 1128 may collapse a 3D space of 3D occupancy 1124 into a BEV space of BEV feature 1126.

Additionally, BEV branch 1130 may process image features 1116 to generate 3D occupancy 1146. BEV branch 1130 may be the same as, may be substantially similar to, and/or may perform the same, or substantially the same, operations as BEV branch 508 of FIG. 5 and FIG. 6.

BEV transformer 1132 of BEV branch 1130 may process image features 1116 to generate BEV features 1134. BEV transformer 1132 may be the same as, may be substantially similar to, and/or may perform the same, or substantially the same, operations as transformer 602 of FIG. 6. BEV features 1134 may be the same as, or may be substantially similar to, BEV features 604 of FIG. 6.

BEV encoder 1136 may process BEV features 1134 and BEV feature 1126 to generate BEV features 1138. In some aspects, BEV encoder 1136 may combine (e.g., concatenate) BEV features 1134 with BEV feature 1126 and process the result to generate BEV features 1138.

BEV processor 1140 may process BEV features 1138 to generate processed BEV features 1142. BEV processor 1140 may be the same as, may be substantially similar to, and/or may perform the same, or substantially the same, operations as processor 606 of FIG. 6. Processed BEV features 1142 may be same as, or may be substantially similar to, processed BEV features 608 of FIG. 6.

Occupancy predictor 1144 may generate occupancy data based on processed BEV features 1142. The occupancy data may be 2D BEV occupancy data, such as 2D features 510 of FIG. 5. The occupancy data may be converted into 3D occupancy 1146, for example, by a converter (not illustrated in FIG. 11B) such as converter 512 of FIG. 5. Occupancy predictor 1144 may be the same as, may be substantially similar to, and/or may perform the same, or substantially the same, operations as occupancy predictor 610 of FIG. 6. 3D occupancy 1146 may be the same as, or may be substantially similar to, 3D occupancy 514 of FIG. 5.

BEV branch 1130 may be trained based on a cross-entropy loss 1148 based on 3D occupancy 1146.

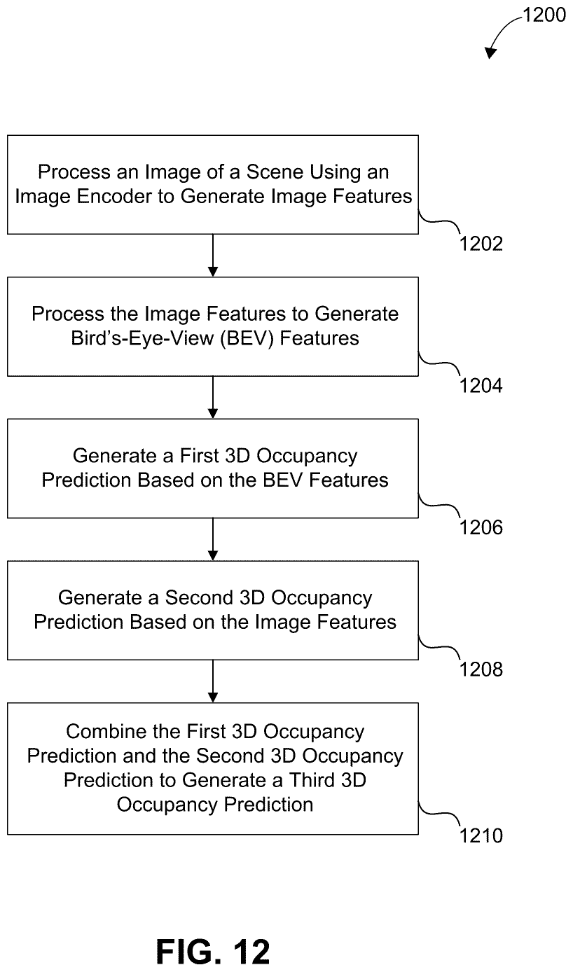

FIG. 12 is a flow diagram illustrating an example process 1200 for generating 3D occupancy data, in accordance with aspects of the present disclosure. One or more operations of process 1200 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1200. The one or more operations of process 1200 may be implemented as software components that are executed and run on one or more processors.

At block 1202, a computing device (or one or more components thereof) may process an image of a scene using an image encoder to generate image features. For example, image encoder 504 may process images 502 to generate image features 506.

At block 1204, the computing device (or one or more components thereof) may process the image features to generate bird's-eye-view (BEV) features. For example, transformer 602 may process image features 506 to generate BEV features 604.

At block 1206, the computing device (or one or more components thereof) may generate a first 3D occupancy prediction based on the BEV features. For example, BEV branch 508 and converter 512 may process BEV features 604 to generate 3D occupancy 514.

In some aspects, to generate the first 3D occupancy prediction, the computing device (or one or more components thereof) may: process the BEV features to generate a 2D occupancy prediction; and convert the 2D occupancy prediction into the first 3D occupancy prediction. For example, BEV branch 508, including processor 606 and occupancy predictor 610, may process BEV features 604 to generate 3D features 510. Converter 512 may convert d features 510 into d occupancy 514.

At block 1208, the computing device (or one or more components thereof) may generate a second 3D occupancy prediction based on the image features. For example, point branch 518 and converter 522 may generate 3D occupancy 524 based on image features 506.

In some aspects, to generate the second 3D occupancy prediction, the computing device (or one or more components thereof) may refine queries based on the image features to generate a 3D prediction; and convert the 3D prediction into the second 3D occupancy prediction. For example, point branch 518, including sampler 704, and one or more instances of cross attention 708, one or more instances of self attention 710, and one or more instances of linear layers 712 may refine queries 702 to generate d features 520. Converter 522 may convert d features 520 into d occupancy 524.

In some aspects, the queries are refined using a cross-attention machine-learning model. In some aspects, the queries are further refined using a self-attention machine-learning model. For example, point branch 518, including sampler 704, and one or more instances of cross attention 708, one or more instances of self attention 710, and one or more instances of linear layers 712 may refine queries 702 to generate d features 520. Converter 522 may convert d features 520 into d occupancy 524.

At block 1210, the computing device (or one or more components thereof) may combine the first 3D occupancy prediction and the second 3D occupancy prediction to generate a third 3D occupancy prediction. For example, combiner 516 may generate 3D occupancy data 526 based on 3D occupancy 514 and 3D occupancy 524.

In some aspects, the first 3D occupancy prediction is generated by a first branch of a machine-learning model; the second 3D occupancy prediction is generated by a second branch of a machine-learning model; and the first branch of the machine-learning model and the second branch of the machine-learning model are trained together in an end-to-end training process. For example, BEV branch 508 and converter 512 may generate d occupancy 514 and point branch 518 and converter 522 may generate d occupancy 524. In some aspects, BEV branch 508 and point branch 518 may be trained in an end-to-end training process.

In some aspects, the first branch of the machine-learning model is trained using training data; the first branch of the machine-learning model is trained using a subset of the training data; and the first branch of the machine-learning model and the second branch of the machine-learning model are trained together using the training data. For example, BEV branch 508 and converter 512 may generate d occupancy 514 and point branch 518 and converter 522 may generate d occupancy 524. In some aspects, BEV branch 508 may be trained using training data. Further, point branch 518 may be trained using a subset of the training data. Further still, BEV branch 508 and point branch 518 may be trained together using the training data.

In some aspects, computing device (or one or more components thereof) may cross attend 2D features of the first branch with 3D features of the second branch to generate combined features, wherein the first 3D occupancy prediction is further based on the combined features. For example, system 800 of FIG. 8, system 900 of FIG. 9, and/or system 1000 of FIG. 10 may apply cross attention (e.g., at cross attention 802, cross attention 902, cross attention 1002, and/or cross attention 1102 respectively) to processed BEV features 608 with 3D features (e.g., queries 702 of FIG. 8, sampled image features 706 of FIG. 9, an output of cross attention 708 of FIG. 10, and/or an output of self attention 710 of FIG. 11).

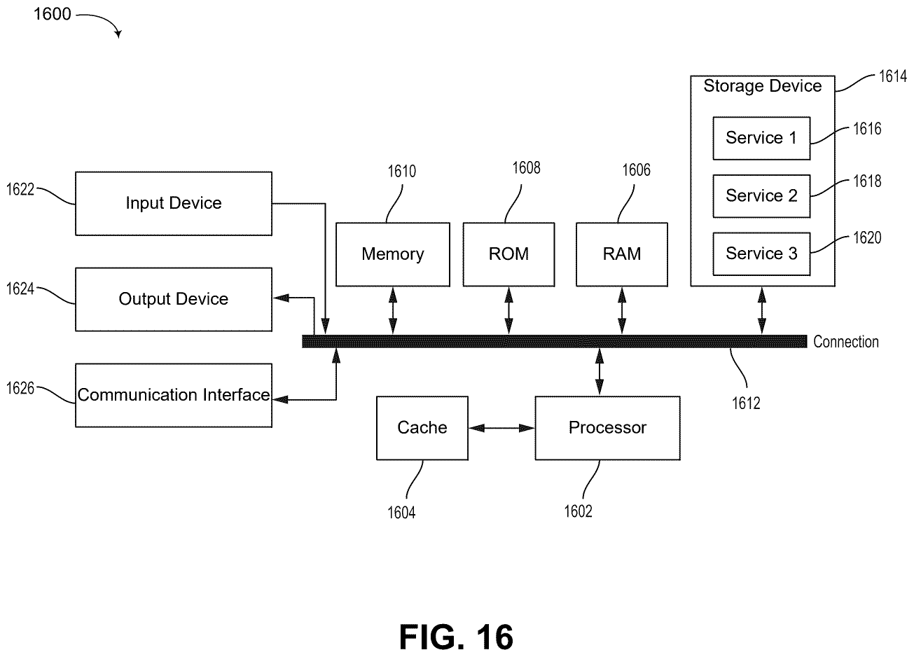

In some examples, as noted previously, the methods described herein (e.g., process 1200 of FIG. 12, and/or other methods described herein) can be performed, in whole or in part, by a computing device or apparatus. In one example, one or more of the methods can be performed by an image capture system, such as system 100 of FIG. 1, a computing system of a vehicle, such as vehicle 402 of FIG. 4, system 500 of FIG. 5, system 800 of FIG. 8, system 900 of FIG. 9, system 1000 of FIG. 10, system 1100 of FIG. 11A, or by another system or device. In another example, one or more of the methods (e.g., process 1200, and/or other methods described herein) can be performed, in whole or in part, by the computing-device architecture 1600 shown in FIG. 16. For instance, a computing device with the computing-device architecture 1600 shown in FIG. 16 can include, or be included in, the components of the system 100, the computing system of vehicle 402, system 500, system 800, system 900, system 1000, and/or system 1100 and can implement the operations of process 1200, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1200, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1200, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

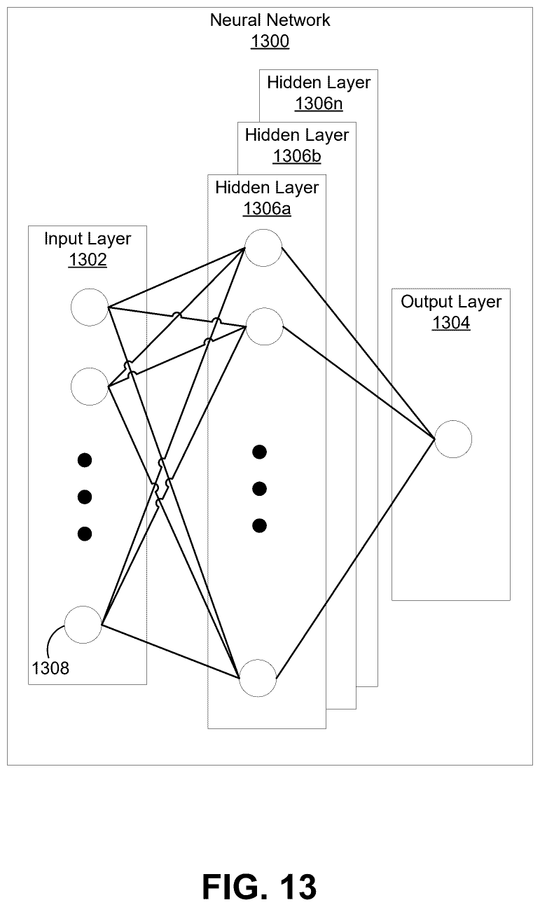

FIG. 13 is an illustrative example of a neural network 1300 (e.g., a deep-learning neural network) that can be used to implement machine-learning based feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 1300 may be an example of, or can implement, one or more of ML model(s) 335 of FIG. 3, image encoder 504 of FIG. 5, one or more layers or elements of BEV branch 508 of FIG. 5, FIG. 6, FIG. 8, FIG. 9, FIG. 10, and FIG. 11A, one or more layer or elements of point branch 518 of FIG. 5, FIG. 7, FIG. 8, FIG. 9, FIG. 10, and FIG. 11A, converter 512 of FIG. 5, converter 522 of FIG. 5, combiner 516 of FIG. 5, transformer 602 of FIG. 6, processor 606 of FIG. 6, occupancy predictor 610 of FIG. 6, sampler 704 of FIG. 7, cross attention 708 of FIG. 7, self attention 710 of FIG. 7, and/or linear layers 712 of FIG. 7.

An input layer 1302 includes input data. Input layer 1302 can include data representing images, features, outputs of other layers, etc. Neural network 1300 includes multiple hidden layers, for example, hidden layers 1306a, 1306b, through 1306n. The hidden layers 1306a, 1306b, through hidden layer 1306n include “n” number of hidden layers, where “n” is an integer greater than or equal to one. The number of hidden layers can be made to include as many layers as needed for the given application. Neural network 1300 further includes an output layer 1304 that provides an output resulting from the processing performed by the hidden layers 1306a, 1306b, through 1306n. In one illustrative example, output layer 1304 can provide features, 2D features, 3D features, 2D BEV features, detections, object detections, 2D object detections, 3D object detections, etc.

Neural network 1300 may be, or may include, a multi-layer neural network of interconnected nodes. Each node can represent a piece of information. Information associated with the nodes is shared among the different layers and each layer retains information as information is processed. In some cases, neural network 1300 can include a feed-forward network, in which case there are no feedback connections where outputs of the network are fed back into itself. In some cases, neural network 1300 can include a recurrent neural network, which can have loops that allow information to be carried across nodes while reading in input.

Information can be exchanged between nodes through node-to-node interconnections between the various layers. Nodes of input layer 1302 can activate a set of nodes in the first hidden layer 1306a. For example, as shown, each of the input nodes of input layer 1302 is connected to each of the nodes of the first hidden layer 1306a. The nodes of first hidden layer 1306a can transform the information of each input node by applying activation functions to the input node information. The information derived from the transformation can then be passed to and can activate the nodes of the next hidden layer 1306b, which can perform their own designated functions. Example functions include convolutional, up-sampling, data transformation, and/or any other suitable functions. The output of the hidden layer 1306b can then activate nodes of the next hidden layer, and so on. The output of the last hidden layer 1306n can activate one or more nodes of the output layer 1304, at which an output is provided. In some cases, while nodes (e.g., node 1308) in neural network 1300 are shown as having multiple output lines, a node has a single output and all lines shown as being output from a node represent the same output value.

In some cases, each node or interconnection between nodes can have a weight that is a set of parameters derived from the training of neural network 1300. Once neural network 1300 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1300 to be adaptive to inputs and able to learn as more and more data is processed.

Neural network 1300 may be pre-trained to process the features from the data in the input layer 1302 using the different hidden layers 1306a, 1306b, through 1306n in order to provide the output through the output layer 1304. In an example in which neural network 1300 is used to identify features in images, neural network 1300 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0010000000].

In some cases, neural network 1300 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 1300 is trained well enough so that the weights of the layers are accurately tuned.

For the example of identifying objects in images, the forward pass can include passing a training image through neural network 1300. The weights are initially randomized before neural network 1300 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1300, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1300 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½ (target-output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1300 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−η dL/dW, where w denotes a weight, wᵢ denotes the initial weight, and η denotes a learning rate. The learning rate can be set to any suitable value, with a high learning rate including larger weight updates and a lower value indicating smaller weight updates.

Neural network 1300 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1300 can include any other deep network other than a CNN, such as an autoencoder, a deep belief nets (DBNs), a Recurrent Neural Networks (RNNs), among others.

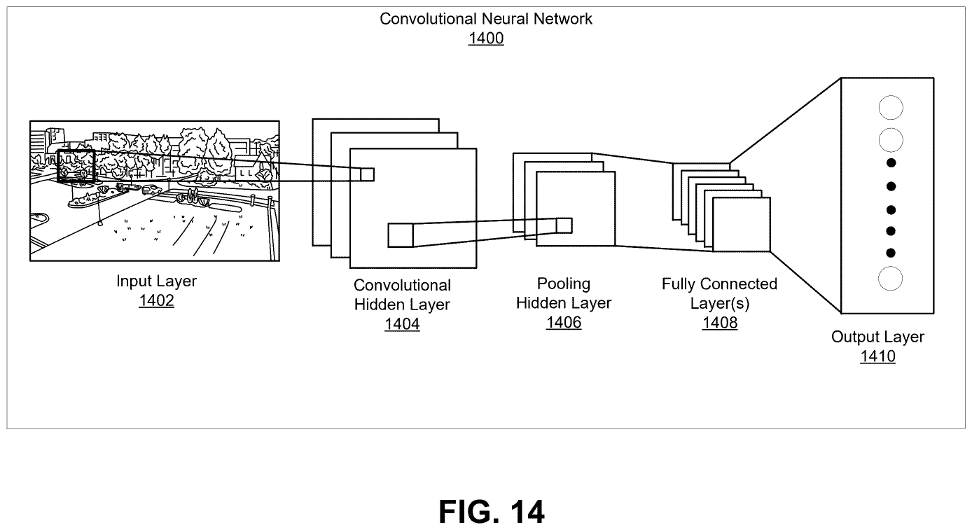

FIG. 14 is an illustrative example of a convolutional neural network (CNN) 1400. The input layer 1402 of the CNN 1400 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1404, an optional non-linear activation layer, a pooling hidden layer 1406, and fully connected layer 1408 (which fully connected layer 1408 can be hidden) to get an output at the output layer 1410. While only one of each hidden layer is shown in FIG. 14, one of ordinary skill will appreciate that multiple convolutional hidden layers, non-linear layers, pooling hidden layers, and/or fully connected layers can be included in the CNN 1400. As previously described, the output can indicate a single class of an object or can include a probability of classes that best describe the object in the image.

The first layer of the CNN 1400 can be the convolutional hidden layer 1404. The convolutional hidden layer 1404 can analyze image data of the input layer 1402. Each node of the convolutional hidden layer 1404 is connected to a region of nodes (pixels) of the input image called a receptive field. The convolutional hidden layer 1404 can be considered as one or more filters (each filter corresponding to a different activation or feature map), with each convolutional iteration of a filter being a node or neuron of the convolutional hidden layer 1404. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1404. Each connection between a node and a receptive field for that node learns a weight and, in some cases, an overall bias such that each node learns to analyze its particular local receptive field in the input image. Each node of the convolutional hidden layer 1404 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1404 is due to each node of the convolutional layer being applied to its corresponding receptive field. For example, a filter of the convolutional hidden layer 1404 can begin in the top-left corner of the input image array and can convolve around the input image. As noted above, each convolutional iteration of the filter can be considered a node or neuron of the convolutional hidden layer 1404. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1404. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1404.

The mapping from the input layer to the convolutional hidden layer 1404 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1404 can include several activation maps in order to identify multiple features in an image. The example shown in FIG. 14 includes three activation maps. Using three activation maps, the convolutional hidden layer 1404 can detect three different kinds of features, with each feature being detectable across the entire image.

In some examples, a non-linear hidden layer can be applied after the convolutional hidden layer 1404. The non-linear layer can be used to introduce non-linearity to a system that has been computing linear operations. One illustrative example of a non-linear layer is a rectified linear unit (ReLU) layer. A ReLU layer can apply the function ƒ(x)=max (0, x) to all of the values in the input volume, which changes all the negative activations to 0. The ReLU can thus increase the non-linear properties of the CNN 1400 without affecting the receptive fields of the convolutional hidden layer 1404.

The pooling hidden layer 1406 can be applied after the convolutional hidden layer 1404 (and after the non-linear hidden layer when used). The pooling hidden layer 1406 is used to simplify the information in the output from the convolutional hidden layer 1404. For example, the pooling hidden layer 1406 can take each activation map output from the convolutional hidden layer 1404 and generates a condensed activation map (or feature map) using a pooling function. Max-pooling is one example of a function performed by a pooling hidden layer. Other forms of pooling functions be used by the pooling hidden layer 1406, such as average pooling, L2-norm pooling, or other suitable pooling functions. A pooling function (e.g., a max-pooling filter, an L2-norm filter, or other suitable pooling filter) is applied to each activation map included in the convolutional hidden layer 1404. In the example shown in FIG. 14, three pooling filters are used for the three activation maps in the convolutional hidden layer 1404.

In some examples, max-pooling can be used by applying a max-pooling filter (e.g., having a size of 2×2) with a stride (e.g., equal to a dimension of the filter, such as a stride of 2) to an activation map output from the convolutional hidden layer 1404. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1404 having a dimension of 24×24 nodes, the output from the pooling hidden layer 1406 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1400.

The final layer of connections in the network is a fully-connected layer that connects every node from the pooling hidden layer 1406 to every one of the output nodes in the output layer 1410. Using the example above, the input layer includes 28×28 nodes encoding the pixel intensities of the input image, the convolutional hidden layer 1404 includes 3×24×24 hidden feature nodes based on application of a 5×5 local receptive field (for the filters) to three activation maps, and the pooling hidden layer 1406 includes a layer of 3×12×12 hidden feature nodes based on application of max-pooling filter to 2×2 regions across each of the three feature maps. Extending this example, the output layer 1410 can include ten output nodes. In such an example, every node of the 3×12×12 pooling hidden layer 1406 is connected to every node of the output layer 1410.

The fully connected layer 1408 can obtain the output of the previous pooling hidden layer 1406 (which should represent the activation maps of high-level features) and determines the features that most correlate to a particular class. For example, the fully connected layer 1408 can determine the high-level features that most strongly correlate to a particular class and can include weights (nodes) for the high-level features. A product can be computed between the weights of the fully connected layer 1408 and the pooling hidden layer 1406 to obtain probabilities for the different classes. For example, if the CNN 1400 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1410 can include an M-dimensional vector (in the prior example, M=10). M indicates the number of classes that the CNN 1400 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

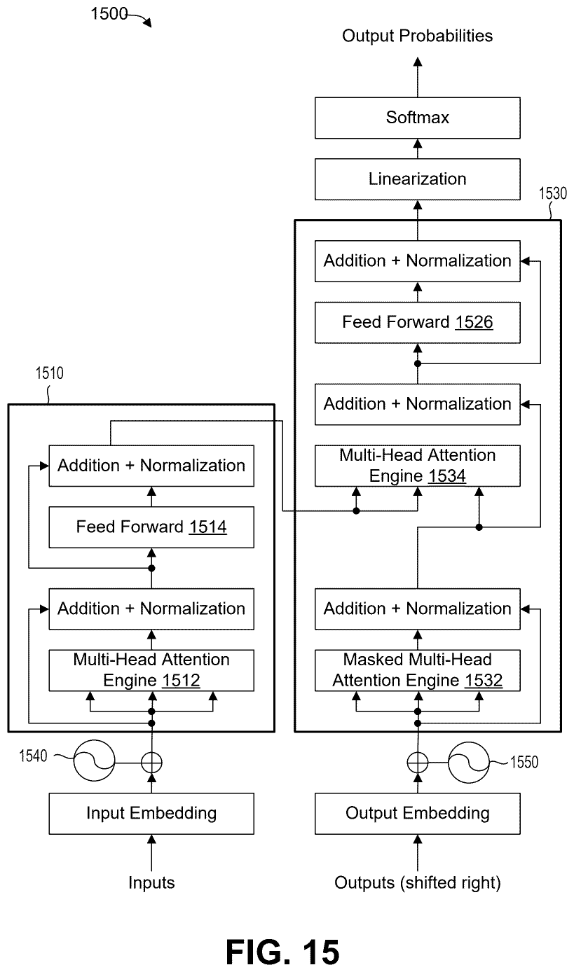

FIG. 15 is a block diagram of an example transformer 1500 in accordance with some aspects of the disclosure. For example, transformer 1500 may be an example of, or can implement, one or more of ML model(s) 335 of FIG. 3, image encoder 504 of FIG. 5, one or more layers or elements of BEV branch 508 of FIG. 5, FIG. 6, FIG. 8, FIG. 9, FIG. 10, and FIG. 11A, one or more layer or elements of point branch 518 of FIG. 5, FIG. 7, FIG. 8, FIG. 9, FIG. 10, and FIG. 11A, converter 512 of FIG. 5, converter 522 of FIG. 5, combiner 516 of FIG. 5, transformer 602 of FIG. 6, processor 606 of FIG. 6, occupancy predictor 610 of FIG. 6, sampler 704 of FIG. 7, cross attention 708 of FIG. 7, self attention 710 of FIG. 7, and/or linear layers 712 of FIG. 7, cross attention 802 of FIG. 8, cross attention 902 of FIG. 9, cross attention 1002 of FIG. 10, and/or cross attention 1102 of FIG. 11A.

In a convolutional neural network (CNN) model, the number of operations required to relate signals from two arbitrary input or output positions grows in the distance between positions, which makes learning dependencies at different distant positions challenging for a CNN model. A transformer 1500 reduces the operations of learning dependencies by using an encoder 1510 and a decoder 1530 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 1510 is composed of a stack of six identical layers and each layer has two sub-layers. The first sub-layer is a multi-head self-attention engine 1512, and the second sub-layer is a fully-connected feed-forward network 1514. A residual connection (not shown) connects around each of the sub-layers followed by normalization.

In this example transformer 1500, the decoder 1530 is also composed of a stack of six 6 identical layers. The decoder also includes a masked multi-head self-attention engine 1532, a multi-head attention engine 1534 over the output of the encoder 1510, and a fully-connected feed-forward network 1526. Each layer includes a residual connection (not shown) around the layer, which is followed by layer normalization. The masked multi-head self-attention engine 1532 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 1540 to encode positions because the model does not contain recurrence and convolution, and relative or absolute position of the tokens is needed. In the transformer 1500, the positional encodings are added to the input embeddings at the bottom layer of the encoder 1510 and the decoder 1530. The positional encodings are summed with the embeddings because the positional encodings and embeddings have the same dimensions. A corresponding position decoder 1550 is configured to decode the positions of the embeddings for the decoder 1530.

In some aspects, the transformer 1500 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 1500 can process input sequences of variable length, making it well-suited for natural language processing tasks where input lengths can vary greatly. Additionally, the self-attention mechanism allows the transformer 1500 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 16 illustrates an example computing-device architecture 1600 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1600 may include, implement, or be included in any or all of an image capture system, such as system 100 of FIG. 1, a computing system of a vehicle, such as vehicle 402 of FIG. 4, system 500 of FIG. 5, system 800 of FIG. 8, system 900 of FIG. 9, system 1000 of FIG. 10, system 1100 of FIG. 11 and/or other devices, modules, or systems described herein. Additionally or alternatively, computing-device architecture 1600 may be configured to perform process 1200, and/or other process described herein.

The components of computing-device architecture 1600 are shown in electrical communication with each other using connection 1612, such as a bus. The example computing-device architecture 1600 includes a processing unit (CPU or processor) 1602 and computing device connection 1612 that couples various computing device components including computing device memory 1610, such as read only memory (ROM) 1608 and random-access memory (RAM) 1606, to processor 1602.

Computing-device architecture 1600 can include a cache of high-speed memory connected directly with, in close proximity to, or integrated as part of processor 1602. Computing-device architecture 1600 can copy data from memory 1610 and/or the storage device 1614 to cache 1604 for quick access by processor 1602. In this way, the cache can provide a performance boost that avoids processor 1602 delays while waiting for data. These and other modules can control or be configured to control processor 1602 to perform various actions. Other computing device memory 1610 may be available for us as well. Memory 1610 can include multiple different types of memory with different performance characteristics. Processor 1602 can include any general-purpose processor and a hardware or software service, such as service 1 1616, service 2 1618, and service 3 1620 stored in storage device 1614, configured to control processor 1602 as well as a special-purpose processor where software instructions are incorporated into the processor design. Processor 1602 may be a self-contained system, containing multiple cores or processors, a bus, memory controller, cache, etc. A multi-core processor may be symmetric or asymmetric.

To enable user interaction with the computing-device architecture 1600, input device 1622 can represent any number of input mechanisms, such as a microphone for speech, a touch-sensitive screen for gesture or graphical input, keyboard, mouse, motion input, speech and so forth. Output device 1624 can also be one or more of a number of output mechanisms known to those of skill in the art, such as a display, projector, television, speaker device, etc. In some instances, multimodal computing devices can enable a user to provide multiple types of input to communicate with computing-device architecture 1600. Communication interface 1626 can generally govern and manage the user input and computing device output. There is no restriction on operating on any particular hardware arrangement and therefore the basic features here may easily be substituted for improved hardware or firmware arrangements as they are developed.

Storage device 1614 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1606, read only memory (ROM) 1608, and hybrids thereof. Storage device 1614 can include services 1616, 1618, and 1620 for controlling processor 1602. Other hardware or software modules are contemplated. Storage device 1614 can be connected to the computing device connection 1612. In one aspect, a hardware module that performs a particular function can include the software component stored in a computer-readable medium in connection with the necessary hardware components, such as processor 1602, connection 1612, output device 1624, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for generating three-dimensional (3D) occupancy data, the apparatus comprising: at least one memory; and at least one processor coupled to the at least one memory and configured to: process an image of a scene using an image encoder to generate image features; process the image features to generate bird's-eye-view (BEV) features; generate a first 3D occupancy prediction based on the BEV features; generate a second 3D occupancy prediction based on the image features; and combine the first 3D occupancy prediction and the second 3D occupancy prediction to generate a third 3D occupancy prediction.
Aspect 2. The apparatus of aspect 1, wherein, to generate the first 3D occupancy prediction, the at least one processor is configured to: process the BEV features to generate a 2D occupancy prediction; and convert the 2D occupancy prediction into the first 3D occupancy prediction.
Aspect 3. The apparatus of any one of aspects 1 or 2, wherein, to generate the second 3D occupancy prediction, the at least one processor is configured to: refine queries based on the image features to generate a 3D prediction; and convert the 3D prediction into the second 3D occupancy prediction.
Aspect 4. The apparatus of aspect 3, wherein the queries are refined using a cross-attention machine-learning model.
Aspect 5. The apparatus of aspect 4, wherein the queries are further refined using a self-attention machine-learning model.
Aspect 6. The apparatus of any one of aspects 1 to 5, wherein: the first 3D occupancy prediction is generated by a first branch of a machine-learning model; the second 3D occupancy prediction is generated by a second branch of a machine-learning model; and the first branch of the machine-learning model and the second branch of the machine-learning model are trained together in an end-to-end training process.
Aspect 7. The apparatus of aspect 6, wherein: the first branch of the machine-learning model is trained using training data; the first branch of the machine-learning model is trained using a subset of the training data; and the first branch of the machine-learning model and the second branch of the machine-learning model are trained together using the training data.
Aspect 8. The apparatus of any one of aspects 6 or 7, wherein the at least one processor is configured to cross attend 2D features of the first branch with 3D features of the second branch to generate combined features, wherein the first 3D occupancy prediction is further based on the combined features.
Aspect 9. A method for generating three-dimensional (3D) occupancy data, the method comprising: processing an image of a scene using an image encoder to generate image features; processing the image features to generate bird's-eye-view (BEV) features; generating a first 3D occupancy prediction based on the BEV features; generating a second 3D occupancy prediction based on the image features; and combining the first 3D occupancy prediction and the second 3D occupancy prediction to generate a third 3D occupancy prediction.
Aspect 10. The method of aspect 9, wherein generating the first 3D occupancy prediction comprises: processing the BEV features to generate a 2D occupancy prediction; and converting the 2D occupancy prediction into the first 3D occupancy prediction.
Aspect 11. The method of any one of aspects 9 or 10, wherein generating the second 3D occupancy prediction comprises: refining queries based on the image features to generate a 3D prediction; and converting the 3D prediction into the second 3D occupancy prediction.
Aspect 12. The method of aspect 11, wherein the queries are refined using a cross-attention machine-learning model.
Aspect 13. The method of aspect 12, wherein the queries are further refined using a self-attention machine-learning model.
Aspect 14. The method of any one of aspects 9 to 13, wherein: the first 3D occupancy prediction is generated by a first branch of a machine-learning model; the second 3D occupancy prediction is generated by a second branch of a machine-learning model; and the first branch of the machine-learning model and the second branch of the machine-learning model are trained together in an end-to-end training process.
Aspect 15. The method of aspect 14, wherein: the first branch of the machine-learning model is trained using training data; the first branch of the machine-learning model is trained using a subset of the training data; and the first branch of the machine-learning model and the second branch of the machine-learning model are trained together using the training data.
Aspect 16. The method of any one of aspects 14 or 15, further comprising cross attending 2D features of the first branch with 3D features of the second branch to generate combined features, wherein the first 3D occupancy prediction is further based on the combined features.
Aspect 17. A non-transitory computer-readable storage medium having stored thereon instructions that, when executed by at least one processor, cause the at least one processor to: process an image of a scene using an image encoder to generate image features; process the image features to generate bird's-eye-view (BEV) features; generate a first 3D occupancy prediction based on the BEV features; generate a second 3D occupancy prediction based on the image features; and combine the first 3D occupancy prediction and the second 3D occupancy prediction to generate a third 3D occupancy prediction.
Aspect 18. The non-transitory computer-readable storage medium of aspect 17, wherein, to generate the first 3D occupancy prediction, the instructions, when executed by at least one processor, cause the at least one processor to: process the BEV features to generate a 2D occupancy prediction; and convert the 2D occupancy prediction into the first 3D occupancy prediction.
Aspect 19. The non-transitory computer-readable storage medium of any one of aspects 17 or 18, wherein, to generate the second 3D occupancy prediction, the instructions, when executed by at least one processor, cause the at least one processor to: refine queries based on the image features to generate a 3D prediction; and convert the 3D prediction into the second 3D occupancy prediction.
Aspect 20. The non-transitory computer-readable storage medium of aspect 19, wherein the queries are refined using a cross-attention machine-learning model.
Aspect 21. The non-transitory computer-readable storage medium of aspect 20, wherein the queries are further refined using a self-attention machine-learning model.
Aspect 22. The non-transitory computer-readable storage medium of any one of aspects 17 to 21, wherein: the first 3D occupancy prediction is generated by a first branch of a machine-learning model; the second 3D occupancy prediction is generated by a second branch of a machine-learning model; and the first branch of the machine-learning model and the second branch of the machine-learning model are trained together in an end-to-end training process.
Aspect 23. The non-transitory computer-readable storage medium of aspect 22, wherein: the first branch of the machine-learning model is trained using training data; the first branch of the machine-learning model is trained using a subset of the training data; and the first branch of the machine-learning model and the second branch of the machine-learning model are trained together using the training data.
Aspect 24. The non-transitory computer-readable storage medium of any one of aspects 22 or 23, wherein the instructions, when executed by at least one processor, cause the at least one processor to cross attend 2D features of the first branch with 3D features of the second branch to generate combined features, wherein the first 3D occupancy prediction is further based on the combined features.
Aspect 25. A non-transitory computer-readable storage medium having stored thereon instructions that, when executed by at least one processor, cause the at least one processor to perform operations according to any of aspects 9 to 16
Aspect 26. An apparatus for providing virtual content for display, the apparatus comprising one or more means for perform operations according to any of aspects 9 to 16.

What is claimed is:

1. An apparatus for generating three-dimensional (3D) occupancy data, the apparatus comprising:
at least one memory; and
at least one processor coupled to the at least one memory and configured to:
process an image of a scene using an image encoder to generate image features;
process the image features to generate bird's-eye-view (BEV) features;
generate a first 3D occupancy prediction based on the BEV features;
generate a second 3D occupancy prediction based on the image features; and
combine the first 3D occupancy prediction and the second 3D occupancy prediction to generate a third 3D occupancy prediction.

2. The apparatus of claim 1, wherein, to generate the first 3D occupancy prediction, the at least one processor is configured to:
process the BEV features to generate a 2D occupancy prediction; and
convert the 2D occupancy prediction into the first 3D occupancy prediction.

3. The apparatus of claim 1, wherein, to generate the second 3D occupancy prediction, the at least one processor is configured to:
refine queries based on the image features to generate a 3D prediction; and
convert the 3D prediction into the second 3D occupancy prediction.

4. The apparatus of claim 3, wherein the queries are refined using a cross-attention machine-learning model.

5. The apparatus of claim 4, wherein the queries are further refined using a self-attention machine-learning model.

6. The apparatus of claim 1, wherein:
the first 3D occupancy prediction is generated by a first branch of a machine-learning model;
the second 3D occupancy prediction is generated by a second branch of a machine-learning model; and
the first branch of the machine-learning model and the second branch of the machine-learning model are trained together in an end-to-end training process.

7. The apparatus of claim 6, wherein:
the first branch of the machine-learning model is trained using training data;
the first branch of the machine-learning model is trained using a subset of the training data; and
the first branch of the machine-learning model and the second branch of the machine-learning model are trained together using the training data.

8. The apparatus of claim 6, wherein the at least one processor is configured to cross attend 2D features of the first branch with 3D features of the second branch to generate combined features, wherein the first 3D occupancy prediction is further based on the combined features.

9. A method for generating three-dimensional (3D) occupancy data, the method comprising:
processing an image of a scene using an image encoder to generate image features;
processing the image features to generate bird's-eye-view (BEV) features;
generating a first 3D occupancy prediction based on the BEV features;
generating a second 3D occupancy prediction based on the image features; and
combining the first 3D occupancy prediction and the second 3D occupancy prediction to generate a third 3D occupancy prediction.

10. The method of claim 9, wherein generating the first 3D occupancy prediction comprises:
processing the BEV features to generate a 2D occupancy prediction; and
converting the 2D occupancy prediction into the first 3D occupancy prediction.

11. The method of claim 9, wherein generating the second 3D occupancy prediction comprises:
refining queries based on the image features to generate a 3D prediction; and
converting the 3D prediction into the second 3D occupancy prediction.

12. The method of claim 11, wherein the queries are refined using a cross-attention machine-learning model.

13. The method of claim 12, wherein the queries are further refined using a self-attention machine-learning model.

14. The method of claim 9, wherein:
the first 3D occupancy prediction is generated by a first branch of a machine-learning model;
the second 3D occupancy prediction is generated by a second branch of a machine-learning model; and
the first branch of the machine-learning model and the second branch of the machine-learning model are trained together in an end-to-end training process.

15. The method of claim 14, wherein:
the first branch of the machine-learning model is trained using training data;
the first branch of the machine-learning model is trained using a subset of the training data; and
the first branch of the machine-learning model and the second branch of the machine-learning model are trained together using the training data.

16. The method of claim 14, further comprising cross attending 2D features of the first branch with 3D features of the second branch to generate combined features, wherein the first 3D occupancy prediction is further based on the combined features.

17. A non-transitory computer-readable storage medium having stored thereon instructions that, when executed by at least one processor, cause the at least one processor to:
process an image of a scene using an image encoder to generate image features;
process the image features to generate bird's-eye-view (BEV) features;
generate a first 3D occupancy prediction based on the BEV features;
generate a second 3D occupancy prediction based on the image features; and
combine the first 3D occupancy prediction and the second 3D occupancy prediction to generate a third 3D occupancy prediction.

18. The non-transitory computer-readable storage medium of claim 17, wherein, to generate the first 3D occupancy prediction, the instructions, when executed by at least one processor, cause the at least one processor to:
process the BEV features to generate a 2D occupancy prediction; and
convert the 2D occupancy prediction into the first 3D occupancy prediction.

19. The non-transitory computer-readable storage medium of claim 17, wherein, to generate the second 3D occupancy prediction, the instructions, when executed by at least one processor, cause the at least one processor to:
refine queries based on the image features to generate a 3D prediction; and
convert the 3D prediction into the second 3D occupancy prediction.

20. The non-transitory computer-readable storage medium of claim 19, wherein the queries are refined using a cross-attention machine-learning model.
